(19) United States
(12) Patent Application Publication
(10) Pub. No.: US 2025/0037028 A1
(43) Pub. Date: Jan. 30, 2025

(54) HARDWARE-SOFTWARE CO-DESIGN FOR EFFICIENT TRANSFORMER TRAINING AND INFERENCE

(71) Applicant: The Trustees of Princeton University, Princeton, NJ (US)

(72) Inventors: Shikhar Tuli, Princeton, NJ (US); Niraj K. Jha, Princeton, NJ (US)

(73) Assignee: The Trustees of Princeton University, Princeton, NJ (US)

(21) Appl. No.: 18/782,768

(22) Filed: Jul. 24, 2024

Related U.S. Application Data
(60) Provisional application No. 63/528,445, filed on Jul. 24, 2023.

(51) Int. Cl. G06N 20/00; G06N 5/04

(52) U.S. Cl. CPC G06N 20/00; G06N 5/04

(57) ABSTRACT

Methods for co-designing transformer-accelerator pairs are provided. The methods may include using a transformer embedding to generate a computational graph and a transformer model. The methods may include running the computational graph through a surrogate model and outputting accuracy data of the surrogate model. The methods may include using an accelerator embedding and the transformer model to simulate training and inference tasks and outputting hardware performance data of the transformer model. The methods may include sending the hardware performance data (such as latency, energy leakage, dynamic energy, and chip area, which may be optimizable performance parameters) and model accuracy data to a co-design optimizer. The methods may include generating an output transformer-accelerator or a transformer-edge-device pair from the co-design optimizer. The transformer model and accelerator embedding may be the output transformer-accelerator or a transformer-edge-device pair.

### CROSS-REFERENCE TO RELATED APPLICATIONS

The present application claims priority to U.S. Provisional Patent Application No. 63/528,445, filed Jul. 24, 2023, the contents of which are incorporated by reference herein in its entirety.

### STATEMENT REGARDING FEDERALLY SPONSORED RESEARCH OR DEVELOPMENT

This invention was made with government support under Grant Nos. CNS-2216746 and CCF-2203399 awarded by the National Science Foundation. The government has certain rights in the invention.

### TECHNICAL FIELD

The present disclosure relates to hardware/software design methodologies, and specifically to a hardware-software co-design method for efficient transformer training and inference.

### BACKGROUND

Currently, all transformer training is implemented on graphical processing units (GPUs) or tensor processing units (TPUs). These hardware platforms are too generic (in terms of handling machine learning processes) and not optimized for transformer dataflows. Further, state-of-the-art transformers are too large (hence the name large language models (LLMs)) to efficiently run on resource-constrained edge/mobile platforms like a Raspberry Pi or a smartphone.

### BRIEF SUMMARY

In various aspects, a method for co-designing transformer-accelerator pairs may be provided. The method may include using a transformer embedding to generate a computational graph and a transformer model. The method may include running the computational graph through a surrogate model and outputting accuracy data of said surrogate model. The method may include using an accelerator embedding and said transformer model to simulate training and inference tasks and outputting hardware performance data of said transformer model. The method may include sending the hardware performance data and model accuracy data to a co-design optimizer. The method may include generating an output transformer-accelerator or a transformer-edge-device pair from said co-design optimizer.

The transformer model and accelerator embedding may be the output transformer-accelerator or a transformer-edge-device pair. The hardware performance data may include latency, energy leakage, dynamic energy, chip area, or a combination thereof. The latency, energy leakage, dynamic energy, chip area, and/or model accuracy may be optimizable performance parameters. The dynamic energy and energy leakage parameters may be optimized where a device's power envelope is highly restricted. The model accuracy may be optimized for server-side deployments.

In various aspects, a system for co-designing transformer-accelerator pairs may be provided. The system may include one or more processing units configured to, collectively, perform various tasks. Such tasks may include: (i) generating a computational graph and transformer model from a transformer embedding; (ii) running the computational graph through a surrogate model and output accuracy data of said surrogate model; (iii) using an accelerator/edge-device embedding and said transformer model to simulate training and/or inference tasks and outputting hardware performance data of said transformer model; (iv) sending the outputted hardware performance data and model accuracy data to a co-design optimizer; and (v) outputting from the co-design optimizer a transformer-accelerator or a transformer-edge-device pair. The hardware performance data may include latency, energy leakage, dynamic energy, and/or chip area.

In various aspects, a non-transitory computer-readable storage medium may be provided. The storage medium may have stored thereon a computer program for execution by one or more processing units. Upon execution by the processing unit(s), the processing unit(s) may, collectively, perform a method for co-designing transformer-accelerator pairs. The method may include: (i) using a transformer embedding to generate a computational graph and a transformer model; (ii) running the computational graph through a surrogate model and outputting accuracy data of said surrogate model; (iii) using an accelerator/edge-device embedding and said transformer model to simulate training and inference tasks and outputting hardware performance data of said transformer model; (iv) sending the hardware performance data and model accuracy data to a co-design optimizer; and (v) generating an output transformer-accelerator or a transformer-edge-device pair from said co-design optimizer. The hardware performance data may include latency, energy leakage, dynamic energy, and/or chip area.

In various aspects, a method for profiling processing unit performance may be provided. The method may include converting a surrogate model to a computational graph and training a machine learning model on said computational graph. The method may include running inferences for a natural language processing task on at least one processing unit. The method may include outputting hardware performance data of the at least one processing unit (such as a graphics processing unit (GPU) or central processing unit (CPU)) generated from the natural language processing task. The hardware performance data may include latency, energy leakage, dynamic energy, and/or chip area.

In various aspects, a method for profiling accuracy of a transformer model may be provided. The method may include converting a set of transformer model architecture parameters to a computational graph. The method may include generating from said computational graph a transformer model. The method may include passing the transformer model through a model training module. The method may include outputting accuracy data of the trained transformer model. The model training module may be tuned during transformer model training.

### BRIEF DESCRIPTION OF FIGURES

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1-3 are flowcharts of methods.

FIG. 4 is a table of memory and compute operations in a transformer.

FIG. 5 is a table showing memory requirements for BERT-Tiny and BERT-Base.

FIG. 6 is a schematic of an AccelTran workflow for an input transformer model and its acceleration in hardware.

FIG. 7 is a schematic of tiling of a matrix multiplication operation along with a selected dataflow (specifically, [b,i,j,k]); here, a tensor is shown instead, with the first dimension being the batch size.

FIG. 8 is a schematic of accelerator organization (dashed lines indicate connections extending through one of the identified blocks)

FIG. 9 is a schematic of internal components of a PE (dashed lines indicate connections extending through one of the identified blocks)

FIG. 10 is a schematic showing architecture of a MAC lane.

FIG. 11 is a schematic showing a DynaTran module. The wires for mask bits are shown with dashed lines.

FIG. 12 is a schematic showing a Pre-compute sparsity module.

FIG. 13 is a schematic showing the flow of simulation in AccelTran.

FIG. 14 is an annotated graph showing scheduling with (a) equal priority and (b) staggered operations for BERT-Tiny's MAC and softmax (SMX) operations.

FIG. 15 is a table showing design choices for AccelTran-Edge and AccelTran-Server.

FIGS. 16A and 16B are plots showing accuracy on the SST-2 task and activation sparsity with (16A) pruning threshold for DynaTran and (16B) pruning “k” for top-k pruning.

FIG. 17 is a plot showing accuracy on the SST-2 task with activation sparsity for DynaTran and top-k methods. The annotations correspond to the maximum achieved accuracy or activation sparsity for each case.

FIG. 18 is a plot showing normalized throughput of DynaTran compared with the top-k method on a CPU and a GPU; annotations are presented over each bar.

FIGS. 19A and 19B are plots showing accuracy/F1-score plotted against net sparsity on the (19A) SST-2 and (19B) SQuAD benchmarks; in DynaTran, WP was implemented with a fixed threshold.

FIG. 20 is plots showing a comparison of energy and reuse instances for all 24 dataflows under three matrix multiplication (W×A) scenarios: (a) W∈ [symbol] ^{4×64×64}, A∈ [symbol] ^{4×64×64}, (b) W∈ [symbol] ^{4×64×64}, A∈ [symbol] ^{4×64×128}, and (c) W∈ [symbol] ^{4x128×64}, A∈ [symbol] ^{4×64×64}; Bar plots represent dynamic energy and dashed lines represent reuse instances.

FIG. 21 is a plot showing a number of stalls with hardware resources.

FIG. 22 is a plot showing the effect of sparsity on throughput and energy consumption; BERT-Tiny is simulated on AccelTran-Edge; normalized throughput and energy are shown as bar plots on the left, and accuracy is shown as a dashed line plot on the right.

FIG. 23 shows normalized throughput (left) and energy (right) comparison for AccelTran with baseline platforms targeted at (a) edge and (b) server applications.

FIG. 24 is a schematic showing an overview of the EdgeTran framework: (a) ProTran used in conjunction with FlexiBERT 2.0 for modeling accuracy along with latency, energy consumption, and peak power draw (hardware measures) for different embedded platforms, using BOSHCODE for co-design, and (b) EdgeTran employs surrogate models obtained from ProTran and FlexiBERT 2.0 to obtain a best-performing model-device pair; this model is forwarded to GPTran for post-processing and further optimization.

FIG. 25 is a table showing a design space description, where super-script (j) depicts the value for layer j.

FIG. 26 is a schematic showing BERT-Tiny in the FlexiBERT 2.0 representation.

FIG. 27 is a schematic showing weight transfer between two neighboring models in FlexiBERT 2.0.

FIG. 28 is a box plot for pairwise distances of 256 sampled embeddings from different sampling schemes.

FIG. 29 is a plot showing model diversity using various sampling schemes.

FIG. 30 is a schematic showing the active-learning pipeline of ProTran.

FIG. 31 is a plot showing validation MSE on the normalized latency values for different sample sizes while using various regressors for the A100 GPU.

FIG. 32 is a schematic of a teacher network in the BOSHCODE surrogate model, where dropout layers have been omitted for simplicity.

FIG. 33 is an algorithm of BOSHCODE.

FIG. 34 is an algorithm of GPTran.

FIG. 35 is a plot showing surrogate modeling performance in terms of (a) ranking performance of the ‘best’ (white) and nDCG (hashed) ranking tests on the left, and (b) test MSE on the GLUE score predictions on the right; absolute test MSE for L-MART is not shown since it is only a relative ranking model.

FIG. 36 is a schematic showing an overview of the TransCODE framework, where (a) ELECTOR takes an accelerator embedding and a transformer computational graph to simulate its training/inference on the given accelerator, (b) FlexiBERT 2.0 converts the input transformer embedding to a computational graph and employs a pre-trained surrogate model to predict model accuracy, and (c) the TransCODE optimizer takes in the performance values of the previously evaluated transformer-accelerator pair to query another pair in the active learning loop.

FIG. 37 is a table showing forward and backward pass operations for matrix multiplication and 1D convolution.

FIG. 38 is a schematic showing implementation of the DynaProp module, the wires for mask bits are shown with dashed lines.

FIG. 39 is a schematic showing the flow of simulation in ELECTOR.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for illustrative purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others. Those skilled in the art and informed by the teachings herein will realize that the invention is also applicable to various other technical areas or embodiments.

The disclosed approach enables optimal design of the hardware (edge device or accelerator) and software (transformer architecture) parameters for efficient training and inference. Previous works are either limited to finding the best transformer architecture for a given hardware platform or vice versa. Disclosed herein is the simultaneous design of the hardware and the software. More specifically, disclosed is a hardware-software co-design method that finds a set of transformer-edge-device or transformer-accelerator pairs for efficient training/inference. Existing set of edge devices like a Raspberry Pi or an iPhone can be used with the disclosed method to boost performance in terms of model accuracy, energy consumption, and peak power draw.

Immediate applications for the disclosed approach include finding the best-performing transformer architecture that maximizes inference efficiency on an existing edge device. Another application is devising a transformer architecture and an application-specific integrated circuit (ASIC)-based accelerator for a given task. At a broader level, this work can be used to make training/inference on edge (and even server) platforms more efficient (relative to using graphical processing units). This could enable faster and more energy-efficient training and inference of large language models (like ChatGPT). The disclosed accelerator can be incorporated into existing edge platforms for more efficient transformer inference.

The disclosed hardware-software co-design pipeline, given a target language modeling task, finds the best-performing set of hardware and software parameters. The hardware parameters include the set of edge devices, or those in the accelerator design space. The accelerator design space is called ELECTOR. It is based on the AccelTran accelerator. The transformer (software) design space is referred to as FlexiBERT 2.0. The disclosed co-design framework, namely BOSHCODE, finds the best-performing pair of hardware and software design decisions.

The disclosed approach was tested on popular transformer architectures (e.g., BERT-Tiny and BERT-Base) and standard evaluation benchmarks [e.g., general language understanding evaluation (GLUE) benchmark]. In addition, the disclosed approach was compared against previous relevant works in terms of accuracy, energy consumption, peak power draw, and chip area (for accelerator design).

The disclosed approach can be used by AI companies (including, e.g., Google, Microsoft, and OpenAI) to make faster and more efficient data centers (leveraging the disclosed accelerator) to run training and inference of their LLMs. Technology companies like Apple, Microsoft, Qualcomm, and Samsung can use the disclosed hardware-software co-design methodology to devise more efficient accelerators in smartphones, tablets, laptops, and desktop computers. These accelerators would enable more efficient and accurate inference of AI-powered assistants, chatbots, etc.

While the disclosed approach may not adapt to dynamic workloads, this can be overcome by running BOSHCODE over regular intervals in order to adapt the hardware parameters (e.g., some accelerator compute modules could be power gated to limit power draw) and the transformer architecture (e.g., model could be pruned with intelligent knowledge transfer for reducing accuracy drop).

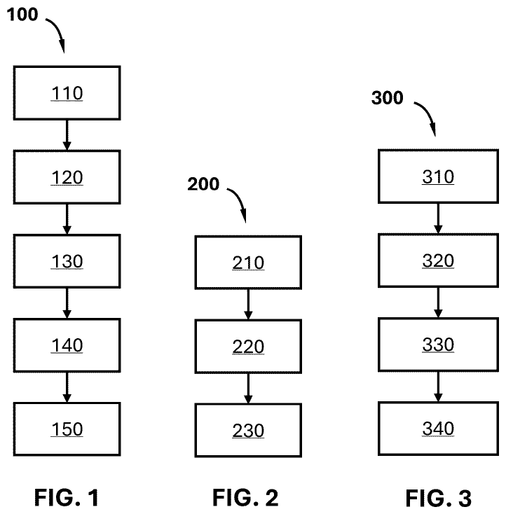

As disclosed herein, a method for co-designing transformer-accelerator pairs may be provided. Referring to FIG. 1, such a method may include using a transformer embedding to generate (110) a computational graph and a transformer model. The method may include running (120) the computational graph through a surrogate model and outputting accuracy data of said surrogate model. The method may include using (130) an accelerator embedding and said transformer model to simulate training and inference tasks and outputting hardware performance data of said transformer model. The method may include sending (140) the hardware performance data and model accuracy data to a co-design optimizer. The method may include generating (150) an output transformer-accelerator or a transformer-edge-device pair from said co-design optimizer. In some embodiments, the transformer model and accelerator embedding may be the output transformer-accelerator or a transformer-edge-device pair.

The hardware performance data may include latency, energy leakage, dynamic energy, and chip area. The latency, energy leakage, dynamic energy, chip area, and model accuracy may be optimizable performance parameters. The dynamic energy and energy leakage parameters may be optimized where a device's power envelope is highly restricted.

The model accuracy may be optimized in various ways as understood in the art. For example, the model accuracy may be optimized for server-side deployments.

A system for co-designing transformer-accelerator pairs may be provided. The system may include one or more processing units configured to, collectively, perform the steps of a method as disclosed herein.

As used herein, the term “processing unit” generally refers to a computational device capable of accepting data and performing mathematical and logical operations as instructed by program instructions. This may include any central processing unit (CPU), graphics processing unit (GPU), core, hardware thread, or other processing construct known or later developed. The term “thread” is used herein to refer to any software or processing unit or arrangement thereof that is configured to support the concurrent execution of multiple operations.

The steps may include generating (110) a computational graph and transformer model from a transformer embedding. The steps may include running (120) the computational graph through a surrogate model and output accuracy data of said surrogate model. The steps may include using (130) an accelerator/edge-device embedding and said transformer model to simulate training and/or inference tasks and outputting hardware performance data of said transformer model. The steps may include sending (140) the outputted hardware performance data and model accuracy data to a co-design optimizer. The steps may include generating (150) (or outputting) a transformer-accelerator or a transformer-edge-device pair from the co-design optimizer.

A non-transitory computer-readable storage medium may be provided. The storage medium may have stored thereon a computer program for execution by a processor configured to perform a method as disclosed herein for co-designing transformer-accelerator pairs.

A method for profiling processing unit performance may also be provided. Referring to FIG. 2, the method (200) may include converting (210) a surrogate model to a computational graph and training a machine learning model on said computational graph. The method may include running inferences (220) for a natural language processing task on at least one processing unit. The method may include outputting (230) hardware performance data of the at least one processing unit generated from the natural language processing task. The hardware performance data may include latency, energy leakage, dynamic energy, and chip area. The at least one processing unit may be a graphics processing unit and/or a central processing unit.

A method for profiling accuracy of a transformer model may be provided. Referring to FIG. 3, the method (300) may include converting (310) a set of transformer model architecture parameters to a computational graph. The method may include generating (320) from said computational graph a transformer model. The method may include passing (330) the transformer model through a model training module. The method may include outputting (340) accuracy data of the trained transformer model. The model training module may be tuned during transformer model training.

To overcome the at least some of the above challenges, disclosed is AccelTran, a novel cycle-accurate accelerator for transformer models.

Proposed is a granular and hardware-aware dynamic inference framework, DynaTran, for transformers that dynamically prunes all activations in order to remove ineffectual MAC operations. DynaTran has much less compute overhead compared to previous works, enabling higher throughput for model inference.

To efficiently execute DynaTran, an ASIC-based architecture called AccelTran is designed and implemented. Instead of using traditional encoder-decoder models, this leverages recently-proposed encoder-only models, thus reducing the critical path by 2× and improving throughput and hardware utilization. Further, unlike previous works, AccelTran's dynamic inference pipeline is agnostic to the pre-processed weight pruning strategy.

The use of tiled matrix multiplication is proposed for the transformer accelerator. For this, a novel mapping scheme is leveraged from the transformer model to the tiled operations that maximizes hardware utilization and improves parallelization.

Various dataflows are formulated and implemented for the transformer optimal dataflow that maximizes data reuse to improve energy efficiency.

Preferably, monolithic-3D RRAM is leveraged for higher memory bandwidth. This alleviates the performance bottleneck in transformer inference since state-of-the-art models are huge and thus memory-bound. The proposed control block maps the transformer computational graph to scheduled hardware-implementable operations. It leverages the high-bandwidth monolithic-3D RRAM to schedule these operations intelligently, enabling high throughput and energy efficiency. LP-DDR3 memory is also supported for low-cost edge solutions.

Next, background is provided on various compute operations employed in a transformer model and previous works on transformer pruning and dynamic inference (sometimes interchangeably termed as dynamic pruning)

### A. The Transformer Model

### 1) Compute Operations:

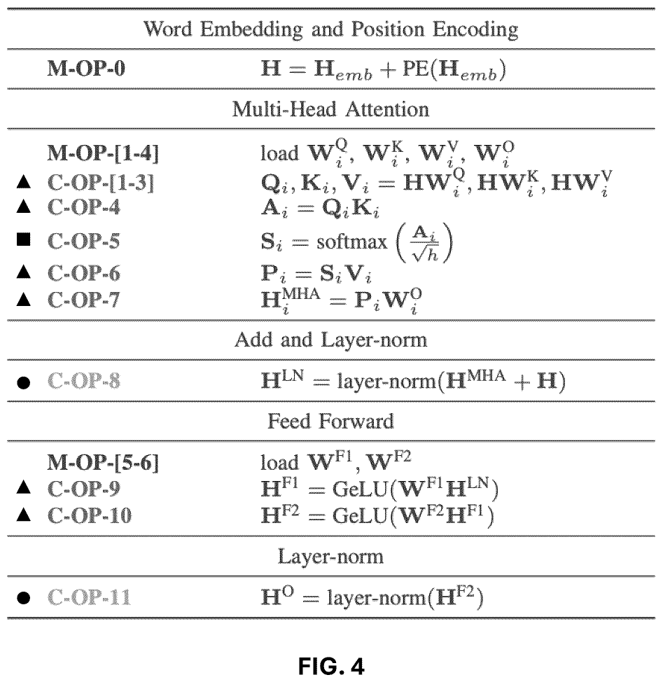

Table I (FIG. 4) summarizes the required memory load and compute operations in a transformer model. The first is the loading of word embeddings and position encodings, which take up a significant fraction of the weights in a transformer. Here, H_{emb} corresponds to the embeddings of all tokens in the vocabulary (for example, vocabulary size is 30,522 for the BERT family of models). Each token is represented by a vector of length h, which is the hidden dimension of the transformer (e.g., h=128 for BERT-Tiny and h=768 for BERT-Base). Then, the weight matrices are loaded for the multi-head attention operations. Here, Wᵢ^{Q}, Wᵢ^{K}, and Wᵢ^{V}∈ [symbol] ^{h×h/n} are needed in each attention head, where n is the number of attention heads. Subsequent compute operations (triangles are shown for matrix multiplication, and squares are shown for softmax in FIG. 4) are employed in self-attention. Intermediate matrices are called activations; those that are loaded from memory are called weights. Wᵢ^{Q}∈ [symbol] ^{h/n×h/n} maps the [symbol] attention probabilities to output scores. Then, the input is added to the output of the multi-head attention (which is formed by concatenating the output of all attention heads) and normalize the resultant matrix. This is the layer-norm operation (indicated with circles) that is used to reduce covariance shifts. Finally, the layer norm feeds the feed-forward operation that, in turn, feeds the layer norm. GeLU is the activation function commonly used in transformers.

### 2) Memory Requirements:

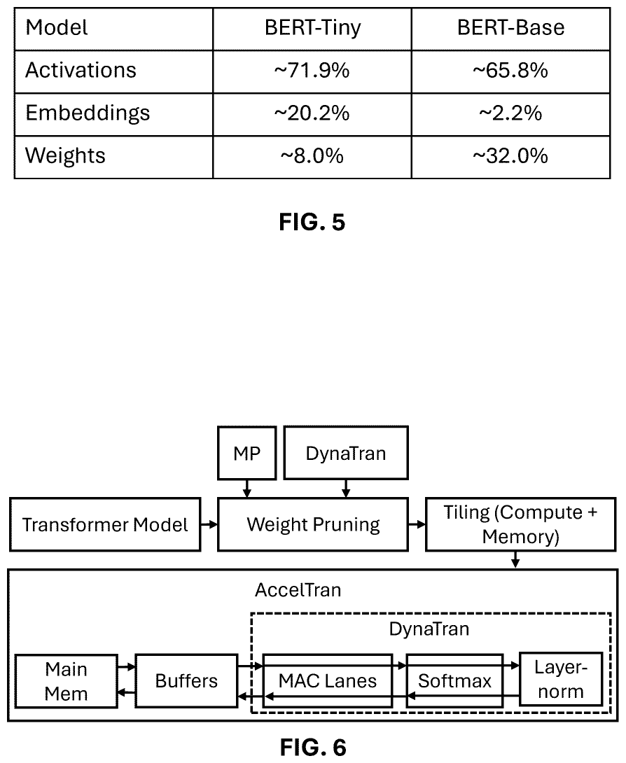

FIG. 5 shows the memory requirements for BERT-Tiny and BERT-Base (5B). BERT-Tiny has higher memory requirements for word and position embeddings (compared with BERT-Base) relative to requirements for weights and activations. Further, activations take up much memory, 8.98× that of the weights for BERT-Tiny and 2.06× for BERT-Base. The total main memory requirements for the two models are 52.8 MB and 3.4 GB, respectively, when only the weights and embeddings are stored. Activations are formed at runtime and stored in internal registers or on-chip buffers. With increasing transformer model sizes (calculated solely in terms of weights), taking into account their operation on hardware accelerators, the memory budget should also have to account for the commensurate increase in activations.

### B. Sparsity in Self-Attention

Researchers have striven to reduce the computational complexity of transformers by pruning, during pre-training or fine-tuning, the transformer weights. Previous works have also proposed various methods to reduce the quadratic complexity of the self-attention operation. Distillation recovers the accuracy loss due to such pruning techniques. However, all these works prune the model while training; more so, they only prune the weights. During inference, sparse matrices with ineffectual values may be formed dynamically from both activations and weights. Such ineffectual values must be pruned at runtime to improve energy efficiency and hardware utilization.

SpAtten proposed the top-k pruning method. It essentially identifies query-key pairs that produce large attention probabilities at runtime. Given an attention score matrix (Si in Table I), it keeps the k largest elements in each row to obtain the probability matrix (Pi) and neglects the rest. Even though this method only results in a minor accuracy loss, it has a high overhead due to its [symbol] (N³) complexity. Further, a matrix multiplication operation benefits from sparsification when small values, which do not have much effect on the final result, are completely pruned out so that the hardware does not have to implement the corresponding MAC operations. SpAtten only considers the attention probabilities (Pi), but not all the matrix multiplication operations presented in Table I. Thus, it loses out on gains that could be obtained by pruning other matrices as well.

### Methodology

FIG. 6 presents a flowchart for the AccelTran simulation pipeline. The method first weight-prunes the transformer that is provided as input, either using movement pruning (MP) or DynaTran. Then, the method tiles the transformer model into granular compute and memory operations. These tiled operations are passed to the AccelTran simulator, which implements the tiled operations, in hardware, in a cycle-accurate manner.

### A. DynaTran

Unlike the top-k pruning algorithm, the method utilizes a low-overhead dynamic inference method that quickly prunes ineffectual weight and activation values at runtime. For a given matrix, which is either loaded as a weight matrix from memory or is an activation matrix obtained from previous MAC operations, DynaTran prunes values with a magnitude less than a given threshold τ. Mathematically, an input matrix M∈ [symbol] ^{m×n} is pruned to MP as follows:

$${M}_{ij}^{P} = \{ \begin{matrix}{M}_{ij} & if \vert {M}_{ij} \vert \geq τ \\ 0 & if \vert {M}_{ij} \vert < τ\end{matrix}$$

This simple comparison operation incurs negligible compute overhead at runtime. This is important since transformer evaluation involves many such matrices at runtime, most of which are on the critical path for model computation. Further, each comparison operation can be parallelized, ensuring that pruning only takes up one clock cycle. This has a much lower overhead compared to SpAtten and Energon that have dedicated engines for this operation. One can now define the pruning ratio (or level of sparsity) for the output matrix as:

$$ρ ( {M}^{P} ) = \frac{{\sum }_{x ∈ {M}^{P}} {δ}_{x , 0}}{m \times n}$$

where δ is the Kronecker delta function. The resultant sparsity in the weights and activations can be profiled for different transformer models on diverse applications to obtain a desired p. One or more such profiled curves can be stored in memory. For the desired values of p, one can determine the corresponding τ at runtime through a simple look-up operation. Such curves are presented below to compare the throughput of the disclosed approach with top-k pruning.

### B. The AccelTran Simulator

### 1) Tiling and Dataflow:

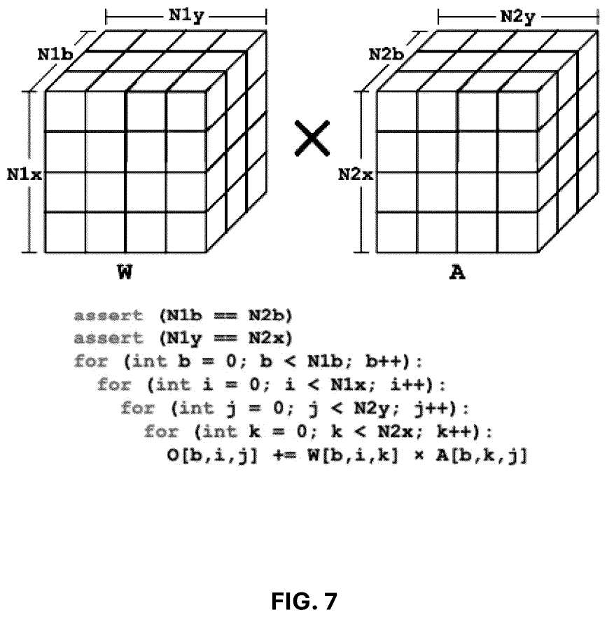

As per Table I, most compute operations in the transformer model are matrix multiplication operations. Thus, it is important to optimize these operations for high gains. Unlike previous works that perform matrix multiplications directly using large MAC units, the method utilizes tiled matrix multiplication (primarily employed by modern GPUs). Tiling the operations helps with better utilization of resources and enables massive parallelization. FIG. 7 shows the tiling operation along with an example dataflow. One can also think of a dataflow as a loop-unrolling scheme. The four for-loops can be unrolled in any permutation (e.g., giving 24 possible ways to unroll the loops, i.e., 24 dataflows). Multiplication between two tiles (say, weights W[b,i,k] and activations A[b,k,j]) is performed by a MAC lane (in parallel, based on the number of MAC units).

Each dataflow results in different data reuse capabilities. For example, if only four MAC lanes are available, with the dataflow shown in FIG. 7, when j changes from 0 to 1 (b and i remaining constant), the MAC lanes can reuse the corresponding weights W[b,i,k], k∈[0, . . . , N2x]. Similarly, other dataflows would result in different reuse capabilities for different input matrix sizes. The reuse instances and corresponding energy savings are discussed later.

### 2) Accelerator Organization:

Taking inspiration from a state-of-the-art CNN accelerator, SPRING, one can leverage monolithic-3D integration to connect to an on-chip 3D resistive random-access memory (RRAM). In monolithic-3D integration, multiple device tiers are fabricated on one substrate wafer, connected through monolithic inter-tier vias that allow much higher density than traditional through-silicon-via-based 3D integration. This leaves much more space for logic and also permits high memory bandwidth, which are crucial for large state-of-the-art transformer models. For scalable edge deployments, the disclosed techniques also support an off-chip dynamic RAM (DRAM).

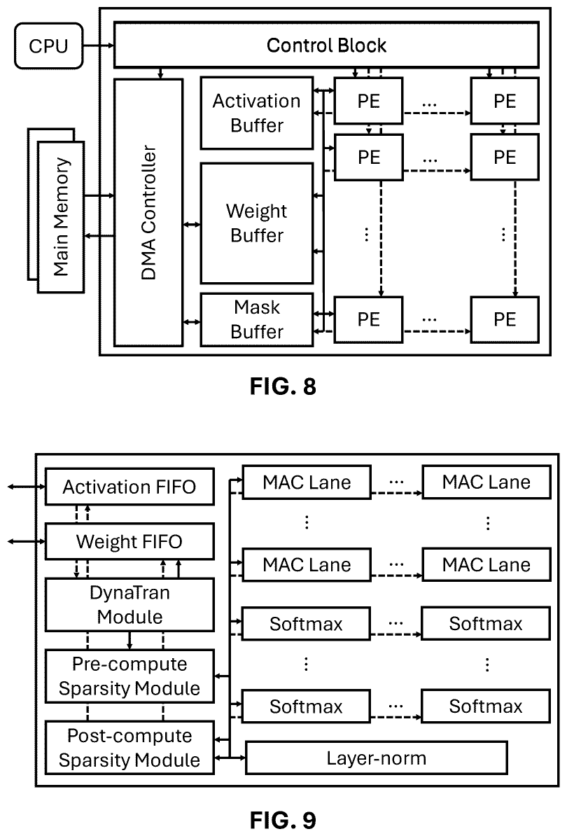

FIG. 8 shows the organization of the accelerator tier in the proposed architecture. The control block takes the instruction stream for the transformer model from the host CPU. The weights and embeddings are brought on-chip from the off-chip DRAM, or from the monolithic-3D RRAM, by the direct memory access (DMA) controller. The activation and the weight buffers store the activations and weights, respectively, in a compressed format (discussed below). Data compression relies on binary masks (stored in the mask buffer). The processing elements (PEs) use the compressed data and the associated masks to perform the main compute operations in the transformer.

### 3) Processing Elements:

FIG. 9 shows the main modules present inside a PE, which is the basic compute block in the disclosed accelerator. The compressed data are stored in local registers of the PE by the activation first-in-first-out (FIFO) and weight FIFO registers. The data then enter the DynaTran module that induces sparsity based on the desired p. As previously noted, this module prunes the given weights or activations based on a pre-calculated threshold τ. The sparse data then enter the pre-compute sparsity module with the binary masks. This module converts the input data into a zero-free format based on the associated masks. The PE then forwards this zero-free data to the MAC lanes (for matrix multiplication), softmax modules (for softmax operation), or the layer-norm module (for layer-norm operation). The zero-free data eliminate any ineffectual computations in these modules. Finally, the post-compute sparsity module implements the inverse of this operation on the output activations, before storing them in the activation FIFO register and, eventually, the main activation buffer.

### MAC Lanes.

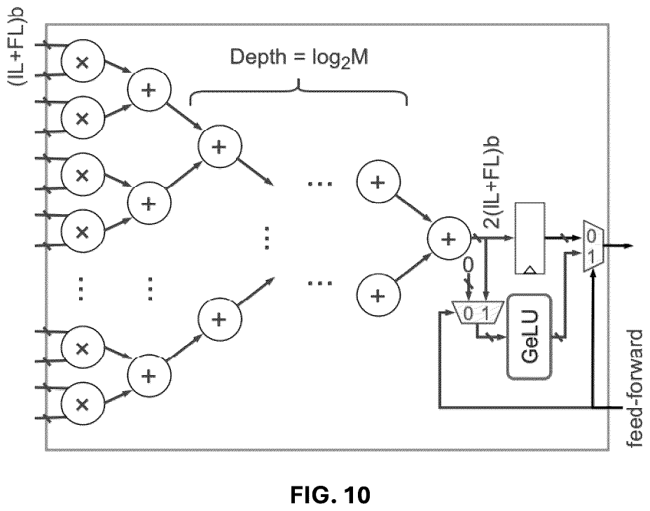

MAC lanes are responsible for multiplication between two tiles in a parallelized fashion. Let the tiles be denoted by W∈ [symbol] ^{b×x×y} and A∈ [symbol] ^{b×y×z} for conserved matrix (in general, tensor) multiplication. Then, the number of multiplication operations is nₒ=b×x×y×z. Each MAC lane in AccelTran has M multipliers. Thus, the minimum number of cycles to compute the tiled operation is nₒ/M. FIG. 10 shows the implementation of a MAC lane. All activation and weight data is stored in fixed-point format with (IL+FL) bits, denoting integer length and fractional length, respectively. The module first feeds the data to the M multipliers, then the corresponding outputs to the adder tree over multiple stages. The products are represented with 2×(IL+FL) bits to prevent overflow. The accumulations also use this bit-width. The depth of the adder tree is log 2M for the M multipliers in the disclosed MAC lane. The module then passes the data to the output register. For feed-forward operations, where activation is required, the GeLU module implements this nonlinearity at the output of the MAC units. All other compute modules also work with the (IL+FL) bits.

### Dynamic Inference Modules.

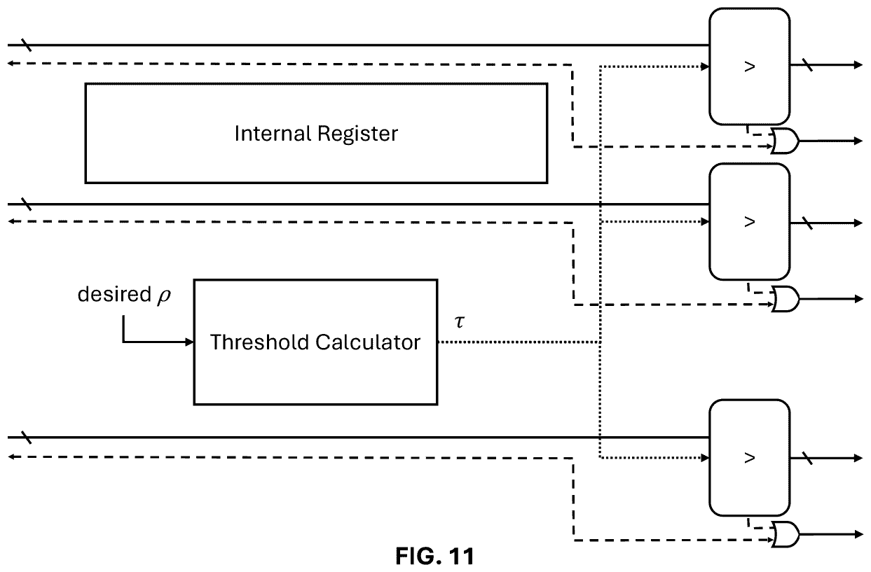

To execute DynaTran pruning, a low-overhead DynaTran module is implemented that prunes ineffectual values in the input activations or weights. As explained previously, the method prunes the values of the input matrices by comparing their magnitude with a pre-determined threshold τ. FIG. 11 shows how this is implemented, in parallel, for the entire tile. For an input tile M∈ [symbol] ^{b×x×y} . . . , one can use b×x×y comparators. The threshold calculator determines the required threshold, using the desired ρ and the pre-profiled transfer functions for different transformer models on diverse applications. The internal register stores these transfer functions loaded from memory before running transformer evaluation. If the output of the comparator is zero, we set the corresponding mask bit to one. Here, the lines carrying mask information are represented as dashed lines, and those carrying activation/weight information in solid black.

### Sparsity-Aware Acceleration.

To exploit sparsity and skip ineffectual activations and weights, and reduce memory footprint, AccelTran uses a binary-mask scheme to encode the sparse data and perform computations directly in the encoded format. Compared to the regular dense format, the pre-compute sparsity module compresses data by removing all the zero elements. In order to retain the shape of the uncompressed data, an extra binary mask is used. The binary mask has the same shape as the uncompressed data, where each binary bit in the mask is associated with one element in the original data vector. If the entry in the mask is 1, it means that the corresponding activation/weight entry is ineffectual and should not be used for further computation.

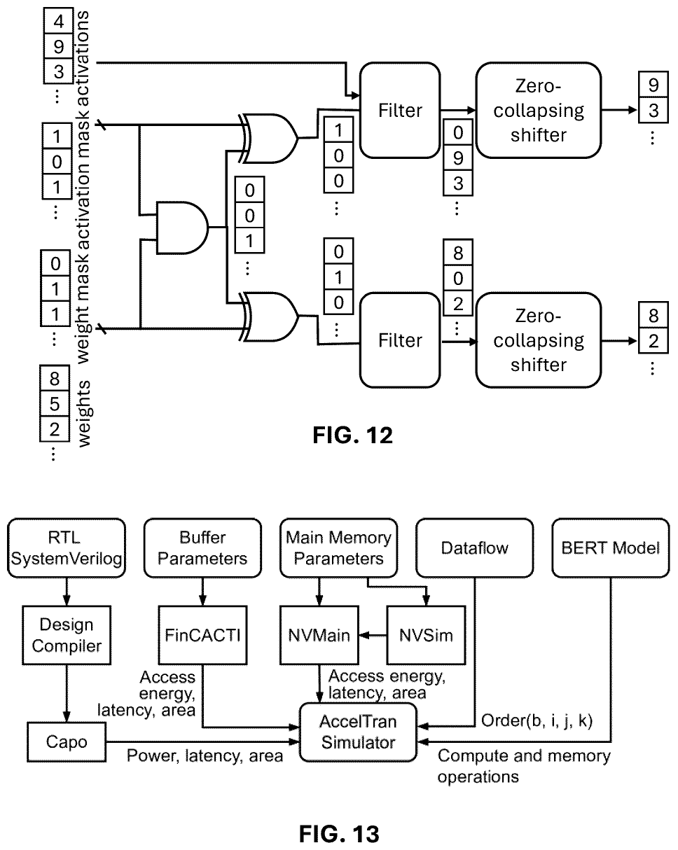

FIG. 12 illustrates the pre-compute sparsity module. It takes the zero-free data and binary mask vectors as inputs and generates an output mask and zero-free activations/weights for the MAC lanes, softmax modules, or the layer-norm module. The output binary mask indicates the common indices of non-zero elements in both the activation and weight vectors. The module computes this mask using a bit-wise AND function over the input activation and weight masks. The two XOR gates then generate the filter masks. Based on the filter masks, the filter prunes the activations/weights. Finally, the zero-collapsing shifter compresses the activations/weights to feed zero-free data to the compute modules for further computation. Thus, we completely skip ineffectual computations, improving throughput and energy efficiency.

### Simulator Flow.

FIG. 13 shows the simulation flow for evaluating the AccelTran architecture. We implement different modules presented above at the register-transfer level (RTL) with SystemVerilog. Design Compiler synthesizes the RTL design using a 14 nm FinFET technology library. Capo, an open-source floorplacer, performs floorplanning. Part of the floorplanning was performed by hand in some examples. The net area reported is after floorplanning (including whitespaces). FinCACTI, a cache modeling tool for deeply-scaled FinFETs, models the on-chip buffers. NVSim and NVMain model the main memory. The synthesized results are then plugged into a Python-based cycle-accurate simulator.

### Smart Scheduling of Tiled Operations.

AccelTran simulates various operations in the transformer model in a tiled fashion. As discussed earlier, each compute operation's activation/weight matrices are tiled. Each such tiled operation is then assigned to a designated module based on the type of compute operation. Modules that are not being used are power-gated to reduce leakage power draw. Transformer inference may run into either memory or compute stalls if the corresponding prerequisites are not met. As the names suggest, a memory stall halts a memory operation from being executed. Similarly, a compute stall halts a compute operation. There is a memory stall if the buffer is not ready to load/store more data as some data are already being written or read. Compute operations require some activations/weights in the buffers. There could be a compute stall if the required matrix is not yet loaded into the buffer. A memory stall can also occur if the compute modules are using current data in the buffer and there is no space left to add more data. This is true until the current data (that are required until compute operations finish) are evicted when the corresponding compute operations are done and the data are no longer required. A memory stall can also occur if the compute operation is not done before storing activation data. Finally, if all compute modules for a specific type of compute operation are busy, it could also lead to a compute stall.

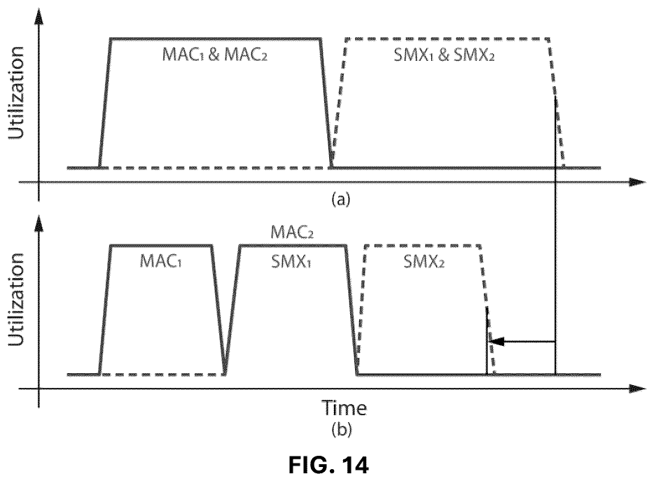

The control block schedules various compute and memory operations to maximize hardware utilization. Since transformer models execute the same sequence of operations for every attention head, assigning equal priority to each head would result in poor usage of specialized resources. Hence, AccelTran staggers the operation of different heads. For instance, in BERT-Tiny, it gives more priority to one head so that the relevant MAC operations are completed first for that head. Then, when the first head reaches the softmax operation, MAC lanes can be assigned to the second head. This results in simultaneous utilization of the MAC lanes and softmax modules, thus increasing hardware utilization and improving throughput. FIG. 14 presents a working schematic of the staggered implementation in BERT-Tiny's MAC and softmax operations (i.e., for two attention heads). In the staggered case, (see 10(b)), MAC lanes and softmax modules can be utilized simultaneously, resulting in a higher parallelization, thus leading to a higher throughput.

### Experimental Setup.

### Evaluation Models and Datasets

To test the efficacy of the proposed dynamic inference method, DynaTran, one can evaluate encoder-only models (because of their high parallelization capabilities) on different tasks. Here, BERT-Tiny and BERT-Base, two commonly used pre-trained models, are used. BERT-Tiny has two encoder layers, each with a hidden dimension h=128 and two attention heads in the multi-head attention operation, as discussed previously. BERT-Base is a larger model with 12 encoder layers, each with a hidden dimension h=768 and 12 attention heads. These encoder-only models can also be extended to machine translation and language generation.

The two models are tested on two representative tasks, namely SST-2 and SQuAD-v2. SST-2 is a popular benchmarking dataset that enables testing of model performance on sentiment analysis tasks. The dataset has 67K sequences in the training set and 872 in the validation set. The performance metric is the accuracy of correctly predicting label sentiment (positive or negative). SQuAD-v2 is a popular question-answering dataset. The training and validation sets have 130K and 12K examples, respectively. The performance metric is the F1 score.

While running DynaTran, both activation and weight sparsity were targeted. Weight sparsity is static and depends on pruning performed during model pre-training or fine-tuning (or even DynaTran's weight pruning, as described later). Activation sparsity changes for every input sequence and is reported as the average over the entire validation set.

### The AccelTran Architectures

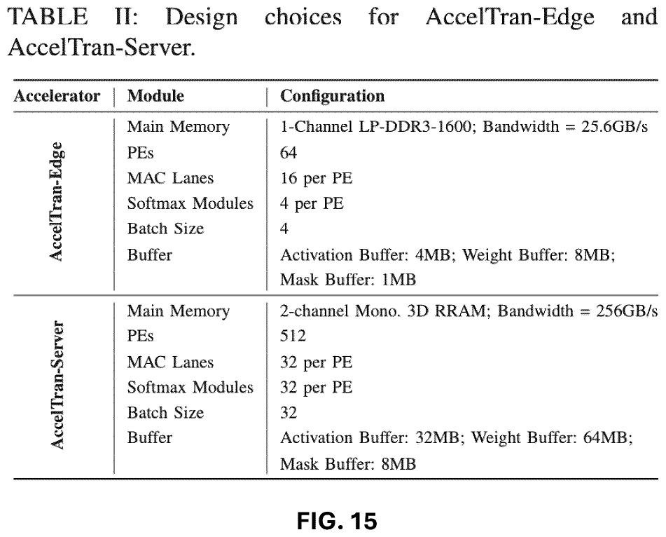

Various design choices for the disclosed framework may be made. Here, two accelerators, namely AccelTran-Edge and AccelTran-Server, are disclosed. The first is for mobile/edge platforms with a limited energy budget. The second is aimed at cloud/server applications where throughput may be of utmost importance. Table II (FIG. 15) shows the associated design choices. The clock rate was fixed to 700 MHz based on the delay of all modules in the proposed architecture. The number of multipliers M was set to 16. IL was set to 4 and FL was set to 16. As disclosed herein, the dataflow [b,i,j,k] is the loop-unrolling scheme of choice. The tile sizes across b, i, and j were set to 1, 16, and 16, respectively. For the chosen RRAM process in AccelTran-Server, the memory was implemented in two tiers above the main accelerator tier in order to fit it within the footprint area. However, different transformer models would generally have a unique set of hardware hyperparameters that are optimal for the given architecture. Thus, one can search for an optimal transformer-accelerator pair over a diverse set of transformer models and accelerator design choices.

### Evaluation Baselines

The performance of the disclosed accelerator are compared with many previously proposed baselines. For mobile platforms, the inference of BERT-Tiny on AccelTran-Edge is compared with off-the-shelf platforms that include Raspberry Pi 4 Model-B that has the Broadcom BCM2711 ARM SoC, Intel Neural Compute Stick (NCS) v2 with its neural processing unit (NPU), and Apple M1 ARM SoC with an 8-core CPU, an 8-core GPU, and 16 GB unified memory on an iPad (for easier evaluations, experiments were performed on a MacBook Pro laptop with the same SoC instead). For server-side platforms, the inference of BERT-Base on AccelTran-Server was compared with a modern NVIDIA A100 GPU (40 GB of video RAM) and previously proposed accelerators, namely, OPTIMUS, SpAtten, and Energon. The maximum batch size possible was chosen for each platform, based on its memory capacity.

To support inference on the Raspberry Pi, the transformer models were implement on an ARM distribution of the machine learning (ML) framework, PyTorch. The transformer evaluation was run on the Intel NCS using the OpenVINO framework. Finally, for the Apple M1 SoC, the Tensorflow-metal plug-in was used to exploit the CPU and its embedded GPU. All models were quantized to FP16 before running the experiments. The throughput, energy, and chip area were normalized to 14 nm FinFET technology using scaling equations. The inverter delays for different technology nodes are used as proxies for throughput normalization.

### Experimental Results

Dynamic Inference with the Transformer
Comparing DynaTran with the Baseline

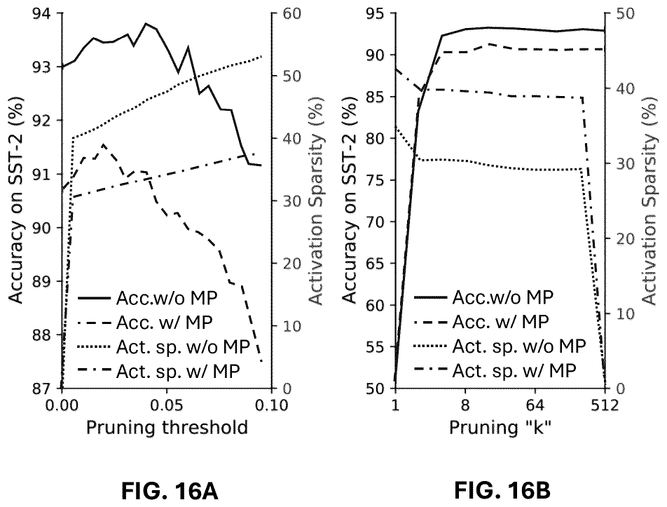

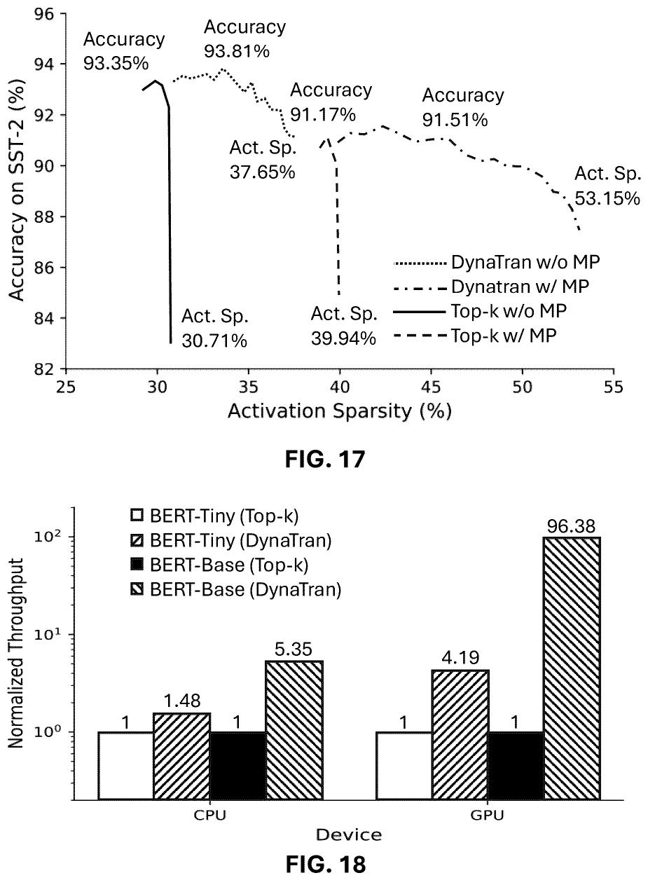

FIGS. 16A, 16B, and 17 present the profiled accuracy curves for BERT-Base on the SST-2 task for DynaTran and top-pruning techniques. In FIG. 16A-16B, the effect of the pruning hyperparameters on sparsity are shown. For DynaTran (16A), the pruning threshold (τ) is varied from 0 to 0.1 and the activations are pruned based on the pruning threshold, as disclosed herein. For top-k pruning (16B), k is changed in powers of two in order to see the effect of net activation sparsity, i.e., the sparsity in all activations rather than only the attention scores. Further, pre-pruned models are also tested to see the impact on net activation sparsity when weights are also pruned. For this, the BERT-Base model is used, pruned using the MP algorithm. Using MP results in a higher activation sparsity (since the activations formed by matrix multiplications with weights are sparser when the weights are also sparse), but at the cost of lower accuracy. As also observed in previous works, both DynaTran and top-k methods see an initial increase in accuracy before a drop, as the sparsity increases. This could be attributed to the over-parameterization of the BERT model and the corresponding pruning method acting as a regularizer, thus giving a slightly higher validation performance.

Similar results are seen for other models and datasets. Geometric mean curves are stored, like the ones disclosed herein, in the internal register of the DynaTran module with a low memory footprint. For the required activation sparsity, or even accuracy, we obtain the corresponding pruning threshold through the threshold calculator in the DynaTran module, as disclosed herein, to implement the desired dynamic inference.

FIG. 17 plots accuracy curves against activation sparsity for the DynaTran and top-k methods with and without MP. These curves can be obtains from those in FIGS. 16A-16B by plotting accuracy against the corresponding resultant activation sparsity for every pruning threshold (τ) or the pruning k, as per the chosen method. One can see the trend of a slight increase in accuracy here as well. DynaTran achieves a higher accuracy (0.46% higher for BERT-Base without MP and 0.34% higher with MP) and a higher possible activation sparsity without much accuracy loss for both cases, i.e., with and without MP. For the same accuracy (the highest achievable by top-k), DynaTran enables 1.17× and 1.20× higher activation sparsity for each case, respectively. On the other hand, DynaTran can achieve up to 1.33× (1.23×) higher sparsity in absolute terms without MP (with MP). Here, we use τ<0.1, which yields reasonable accuracy values.

One can compare the compute cost of the top-k method with that of DynaTran. FIG. 18 shows the normalized throughputs of the two methods for BERT-Tiny and BERT-Mini on two devices. These are a 2.6 GHz AMD EPYC Rome CPU with 128 cores and 768 GB memory and an A100 GPU with 40 GB VRAM. DynaTran achieves up to 96.38× higher throughput on the GPU and up to 5.35× higher throughput on the CPU. This is due to the use of low-overhead comparators with a pre-determined threshold. Even with the specialized top-k engine used in SpAtten and the approximation scheme used in Energon, they use more than one clock cycle, whereas DynaTran uses just one clock cycle. This is because the threshold calculator only needs a simple look-up operation and the comparators can execute within a clock cycle.

### Testing if Weight Pruning is Effective in DynaTran

DynaTran implements magnitude-based pruning of all activations at runtime. However, one can also leverage it to prune model weights before running the transformer. This may be called weight pruning (WP) since only the transformer weights are pruned. In this disclosed approach, one does not need downstream training, as opposed to MP, which iteratively trains model weights while also pruning them.

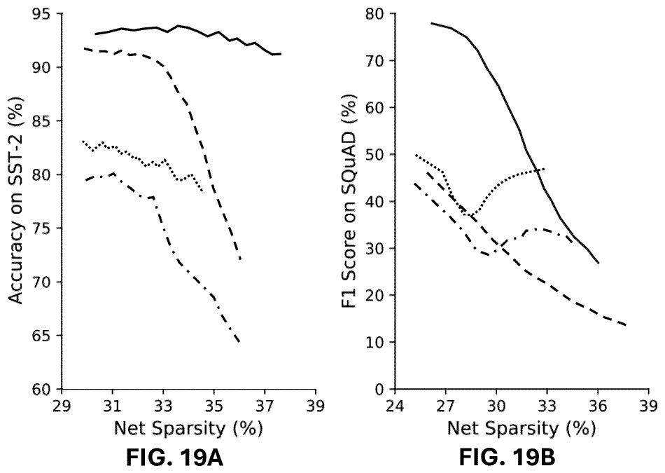

FIGS. 19A-19B present the accuracies and F1-scores on the SST-2 (19A) and SQuAD (19B) datasets, respectively, with and without the use of WP. Net sparsity represents the combined sparsity of weights and activations. WP results in slightly higher net sparsity, however, with a significant loss in performance. The high ratio of activations compared to weights (see FIG. 5) results in only marginal gains in net sparsity. Hence, one preferred embodiment does not employ WP in DynaTran. One can use movement-pruned models instead, resulting in high weight and activation sparsities (with DynaTran) at negligible performance loss.

### Dataflows and Data Reuse

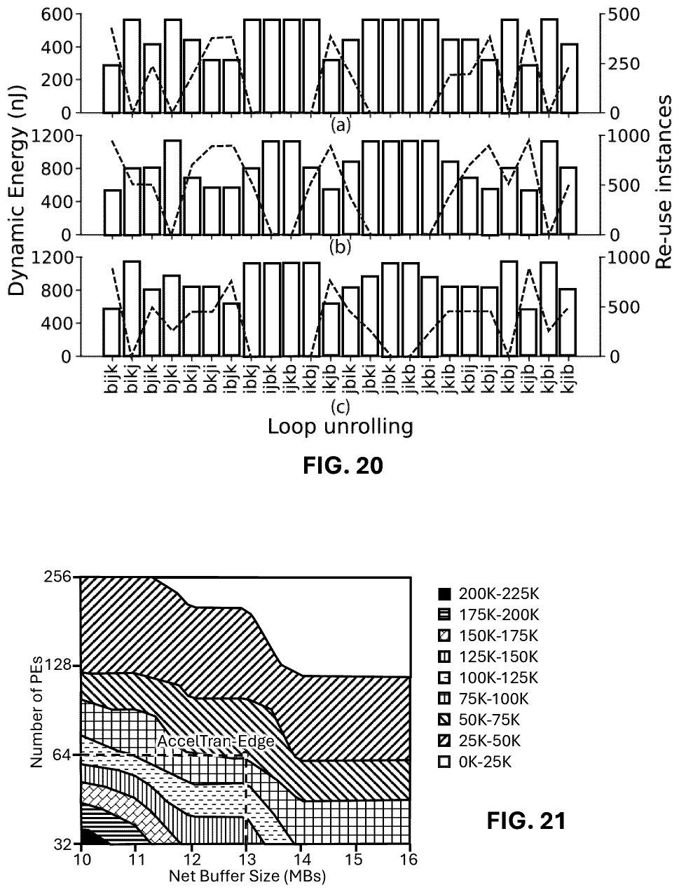

One can pass on different tiles to available resources based on the four for-loops shown in FIG. 7. One can arrange these four for-loops in ⁴P₄=24 ways without changing the output. However, based on the compute resource constraints, different loop-unrolling strategies, or dataflows, can result in the reuse of local tiled weights or activations. FIG. 20 compares these dataflows for various matrix multiplication operations. The multiplication, W×A, is carried out using four MAC lanes in this simple example. It is observed that dynamic energy is minimized by dataflows [b,i,j,k] and [k,i,j,b]. We use the former dataflow for subsequent experiments. These two dataflows also have maximum reuse instances for all three matrix multiplications. A reuse instance indicates if a weight or activation tile is reused in the internal register of a MAC lane. Many dataflows have the same energy and reuse instances due to symmetry. Since AccelTran hides data transfer overheads, due to the optimized control flow, the net latency is the same for all dataflows (this also results in the same leakage energy).

Next, one can test the effect of the different dataflows on real-world traces with the BERT-Tiny model on AccelTran-Edge. However, negligible energy differences were observed among the dataflows. This could be attributed to massive parallelization being at odds with data reuse. For instance, to reuse the same set of tiled weights in a PE's register, the next operation using those weights would have to be assigned to the same PE rather than exploit other free PEs, thus limiting parallelization. Hence, as per FIG. 20, the advantages of data reuse can only be exploited in highly resource-constrained accelerators.

### Design Space Exploration

FIG. 21 shows a plot of the number of compute and memory stalls when evaluating BERT-Tiny with different number of PEs and buffer sizes. A 4:8:1 size ratio is used for the activation, weight, and mask buffers. This ratio was found to be close to the optimal based on empirical studies on memory access patterns for the BERT-Tiny model. Next, the net buffer size was swept from 10 MB to 16 MB. Finally, the following number of PE were chosen: 32, 64, 128, and 256. The figure shows that the number of compute stalls gradually increases as both the number of PEs and buffer size are reduced. This is justified as follows.

A lower number of PEs results in increased compute stalls since the compute operations have to wait for resources to free up in order to execute them, limiting available parallelization. In addition, a small buffer size results in memory stalls since memory store operations have to wait for the corresponding compute operations to finish before the current activations or weights, initially required by those compute operations, can be evicted from the buffer. FIG. 21 shows the chosen point for AccelTran-Edge. This set of design choices (64 PEs and 13 MB net buffer size) represents a reasonable trade-off between the number of stalls (that directly increase latency) and hardware resources (that directly increase area and power consumption). An automatic hardware-software co-design approach could also efficiently test different buffer sizes, along with the corresponding ratios that may be optimal for each transformer model.

### Hardware Performance and Utilization

The power consumption and resource utilization of various models was also considered, such as that of BERT-Tiny on AccelTran-Edge during inference of one batch. Hardware utilization remains at zero until around 51K cycles, when the accelerator loads the word and position embeddings into the weight buffer (accounting for around 60% of the weight buffer). However, these load operations only occur once and subsequent transformer evaluations on different sequences reuse these embeddings. The rest of the process sees high utilization of MAC lanes or softmax modules. At certain times, the accelerator uses both MAC lanes and softmax modules due to the staggered implementation of attention head operations. The leakage power is low, due to the power-gating of unused modules. Buffer usage drops suddenly, at certain instances when data are evicted in order to make space for new data for the active compute operations.

Table III (below) shows the hardware performance measures for the proposed accelerator architectures, namely AccelTran-Server and AccelTran-Edge, along with a low-power (LP) mode that is supported for AccelTran-Edge.

TABLE III
Area, theoretical peak TOP/s, and minimum main memory requirements, along
with power consumption breakdown for different parts of the proposed accelerator
architectures. The LP mode for AccelTran-Edge is also considered.

| | | | Main | Power Breakdown (W) | | | |
|---|---|---|---|---|---|---|---|
| Accelerator/ | Area | | Mem. | | | Main | |
| Operation | (mm²) | TOP/s | (MB) | PEs | Buffers | Mem. | Total |
| AccelTran-Server | 1950.95 | 372.74 | 3467.30 | 48.25 | 10.40 | 36.86 | 95.51 |
| AccelTran-Edge | 55.12 | 15.05 | 52.88 | 3.79 | 0.08 | 2.91 | 6.78 |
| AccelTran-Edge | 55.12 | 7.52 | 52.88 | 2.31 | 0.05 | 1.77 | 4.13 |
| (LP mode) | | | | | | | |

The LP mode only works with half of the compute hardware at any given time, resulting in lower net power draw, which is often a constraint in edge devices that rely on a battery source. We show the chip area first. AccelTran-Server is a massive chip with an area of 1950.95 mm², although still lower than that of the A100 GPU (3304 mm² normalized to a 14 nm process). This can reduce the yield. However, one can leverage intelligent placement of PEs and binning to improve apparent yield rates. The tera-operations per second (TOP/s) performance measure for both architectures is also shown. AccelTran-Server can theoretically achieve a peak performance of 372.74 TOP/s, assuming all compute modules are operational simultaneously. The minimum main memory size required for each accelerator is also presented. The net size of the embeddings and weights for BERT-Base and BERT-Tiny are 3467.30 MB and 52.88 MB (assuming a conservative 50% weight sparsity ratio), respectively. However, transformer evaluation does not require all weights at any given time. Thus, the weight buffer can be much smaller. Similarly, even though the net size of activations is much higher (see FIG. 5), one can use a much smaller activation buffer. Finally, the power breakdowns for both the accelerators and the LP mode for AccelTran-Edge are presented. The LP mode reduces power consumption by 39.1%, while lowering throughput by 38.7%, for BERT-Tiny.

TABLE IV
Breakdown of Area and Power Consumption
By Compute Modules in AccelTran-Edge.

| Module | Area | Power Consumption |
|---|---|---|
| Softmax | 44.7% | 49.9% |
| MAC Lanes | 19.2% | 39.3% |
| Layer-norm | 10.3% | 0.6% |
| Sparsity | 15.1% | 4.1% |
| Others | 10.7% | 6.1% |

The area and power breakdowns for different compute modules in AccelTran-Edge are shown in Table IV. The 1024 MAC lanes only take up 19.2% of the area, while the specialized 256 softmax and 64 layer-norm modules take up 44.7% and 10.3% of the area, respectively. Pre- and post-compute sparsity modules comprise 15.1% area, while the dataflow, the DynaTran modules, and the DMA occupy 10.7% of the chip area. FIG. 18(b) shows the average power breakdown. Since most operations in the transformer involve matrix multiplication or softmax, they also draw most of the power (39.3% for MAC lanes and 49.9% for softmax modules). The high power consumption of the softmax modules can be attributed to the calculation of the exponential sum over the entire tile in a parallel manner.

### Effect of Sparsity on Throughput and Energy

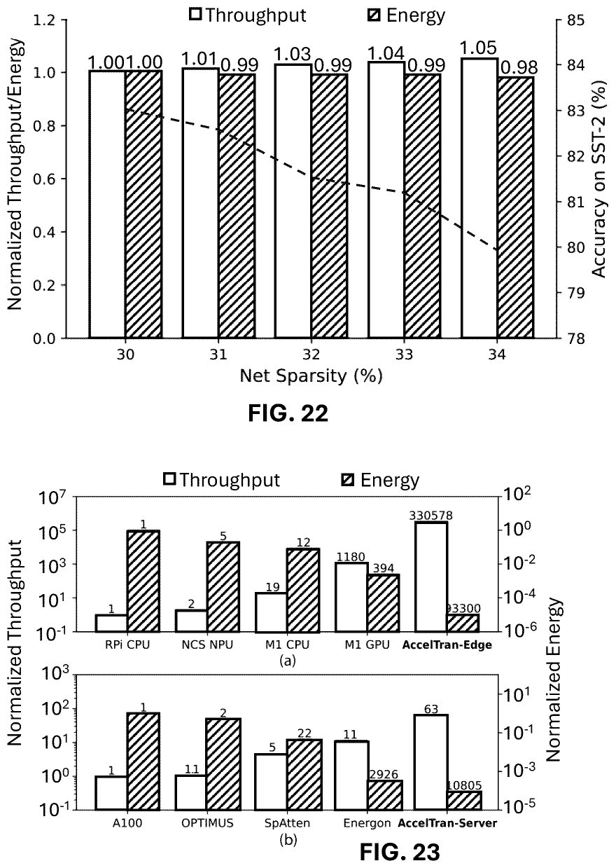

FIG. 22 shows the effect of increasing sparsity on accelerator throughput and energy consumption. As the net sparsity increases from 30% to 34% for the BERT-Tiny model (with a conservative 50% weight sparsity estimate and accordingly tuned DynaTran's thresholds), throughput improves by 5% whereas energy consumption drops by 2%, when implemented on AccelTran-Edge. Here, accuracy drops by only 3% due to the low performance loss of DynaTran.

### Performance Improvements

FIG. 23 shows performance comparisons of AccelTran architectures with baseline platforms. For edge applications, the inference of BERT-Tiny on AccelTran-Edge is compared with that on Raspberry Pi CPU, Intel NCS NPU, M1 CPU, and M1 GPU. AccelTran-Edge achieves 330,578× higher throughput at 93,300× lower energy consumption relative to Raspberry Pi. On the server side, the performance of BERT-Base on AccelTran-Server is compared with that of A100 GPU and some recently proposed accelerators, namely, OPTIMUS, SpAtten, and Energon-Server. The throughput and energy values for SpAtten and Energon are normalized with respect to the A100 GPU. AccelTran-Server achieves 63× (5.73×) higher throughput at 10,805× (3.69×) lower energy consumption when compared to off-the-shelf A100 GPU (state-of-the-art Energon co-processor). These gains can be attributed to the execution of the DynaTran algorithm at runtime along with sparsity-aware modules that skip ineffectual computations. The specialized softmax and layer-norm modules also speed up the respective operations, otherwise implemented as matrix multiplications in the A100. Further, monolithic-3D RRAM has much lower data-retrieval latency than HBM in the A100. These contributions enable AccelTran to achieve high throughput gains over the A100 GPU. The effects of these contributions are considered next.

### Ablation Analysis

Table V presents an ablation analysis for the inference of BERT-Tiny on AccelTran-Server. The first row corresponds to the selected AccelTran configuration as per Table II, with 50% weight sparsity implemented through MP and 50% activation sparsity at runtime through DynaTran. The second row corresponds to the case not leveraging DynaTran. Then, the accelerator is tested when the BERT model is not weight-pruned using MP. Third, it is tested without employing the pre- and post-sparsity modules to skip ineffectual MAC operations. Finally, results when AccelTran-Server utilizes an off-chip LP-DDR3 DRAM instead of a high bandwidth monolithic-3D RRAM are presented. Although the use of DRAM leads to a lower net average power consumption than when monolithic-3D RRAM is used, its total energy is higher due to a much lower throughput.

TABLE V
Ablation analysis for inference of BERT-Tiny on AccelTran-Server

| | Throughput | Energy | Net Power |
|---|---|---|---|
| Accelerator Configuration | (seq/s) | (mJ/seq) | (W) |
| AccelTran-Server | 172,180 | 0.1396 | 24.04 |
| w/o DynaTran | 93,333 | 0.1503 | 14.03 |
| w/o MP | 163,484 | 0.2009 | 32.85 |
| w/o Sparsity-aware modules | 90,410 | 0.2701 | 24.43 |
| w/o Monolithic-3D RRAM | 88,736 | 0.1737 | 15.42 |

Separately, disclosed is a framework, called ProTran, to profile the hardware performance measures for a design space of transformer architectures and a diverse set of edge devices. This profiler can be used in conjunction with the disclosed co-design technique to obtain the best-performing models that have high accuracy on the given task and minimize latency, energy consumption, and peak power draw to enable edge deployment. The framework for co-optimizing accuracy and hardware performance measures can be referred to as EdgeTran. It searches for the best transformer model and edge device pair. Finally, GPTran is proposed, a multi-stage block-level grow-and-prune post-processing step that further improves accuracy in a hardware-aware manner. The obtained transformer model is 2.8× smaller and has a 0.8% higher GLUE score than the baseline (BERT-Base). Inference with it on the selected edge device enables 15.0% lower latency, 10.0× lower energy, and 10.8× lower peak power draw compared to an off-the-shelf GPU.

Disclosed is the extension of a previously proposed state-of-the-art benchmarking framework, called FlexiBERT, to FlexiBERT 2.0. It uses an expanded design space of diverse transformer architectures for multiple edge-AI devices, targeting both training and inference. FlexiBERT 2.0 supports a finer-grained transfer of weights and increased heterogeneity compared to the original FlexiBERT framework, thus speeding up architecture search. It also supports a much more massive design space (10⁷⁹× larger) for mobile-friendly architectures, enabling a thorough search of the optimal architecture for the given edge platform.

The latency, energy consumption, and peak power draw of the transformer models are measured in the proposed design space. This profiling framework is called ProTran. It can obtain these hardware performance measures for a design space of transformer architectures on a given edge platform. It leverages an active-learning pipeline to efficiently train surrogate models, minimizing the sample complexity of evaluation queries. It also supports various regression frameworks, including Gaussian process regression (GPR), decision tree (DT), boosted decision tree (BDT), and a state-of-the-art method, called BOSHNAS that exploits gradient-based optimization using backpropagation to inputs and heteroscedastic modeling to minimize overall uncertainty in the estimation of each measure. Using the proposed ProTran and FlexiBERT 2.0 frameworks, any new edge device can be profiled within hours for subsequent quick transformer architecture search under user-defined constraints.

Then ProTran's surrogate models and the proposed accuracy predictors are used as a foundation for a disclosed fast and efficient co-design method for edge devices: EdgeTran. This co-design approach yields models with high accuracy but low latency, energy consumption, and peak power draw. The co-design framework leverages Bayesian optimization using second-order gradients and heteroscedastic surrogate modeling for co-design (BOSH-CODE). It searches for optimal model-device pairs with the given constraints, wherein it simultaneously chooses the edge device that performs best in terms of latency, energy consumption, and peak power draw while evaluating the searched transformer model architecture with high accuracy. It can be used by academia and industry for scalable and streamlined deployments in a range of NLP tasks, targeting edge/cloud platforms.

Finally, a block-level multi-stage grow-and-prune post-processing step, GPTran, is proposed, that further optimizes accuracy and hardware performance by adapting the structure of the converged transformer model.

### Transformer Architectures

Previous works have proposed various transformer architectures. BERT is one of the most popular architectures that is widely used for language modeling. Its variants leverage mechanisms other than vanilla self-attention to optimize performance or reduce model size and complexity. They include RoBERTa that implements robust pre-training techniques, ConvBERT that uses one-dimensional convolutional operations, MobileBERT that uses bottleneck structures and multiple feed-forward stacks, SqueezeBERT that uses grouped convolution operations to approximate the feed-forward stack, among others. Further, architectures like FNet and LinFormer use Fourier transform and low-rank approximation, respectively, of the self-attention operation to aid efficiency and reduce the number of model parameters.

To obviate the need for hand-designed optimizations of the transformer model, many works devise design spaces to search for optimal architectural design decisions in a unified manner. For instance, SchuBERT uses a design space of transformer architectures but does not consider different types of attention operations and only includes homogeneous models (i.e., with the same encoder layer for every model) in the design space. DynaBERT adapts the width of the network by varying the number of attention heads and not the dimensionality of representation for each head. This only rep-resents a simple extension to traditional architectures and does not target heterogeneity, much like other works that formulate design spaces for transformer architectures.

On the other hand, FlexiBERT, a state-of-the-art bench-marking framework for diverse transformer architectures, incorporates the most popularly used attention operations in a design space of heterogeneous and flexible transformer architectures. Each encoder layer in its design space can have a different attention mechanism (heterogeneity) and a different hidden dimension (flexibility). This leads to a vast design space consisting of 3.32×10⁹ models, resulting in high gains in model performance for the same number of parameters. The FlexiBERT surrogate model can also be used to predict the accuracy of any queried transformer in its design space (within reasonable uncertainty bounds).

However, FlexiBERT's design space is not diverse enough to incorporate mobile-friendly architectures, has high training overhead while transferring weights to new models, and only supports the PyTorch platform, making it impractical for many edge devices. Nevertheless, taking inspiration from the advantages offered by flexible and heterogeneous models and the benefits of expanding the search space to obtain better-performing models, this framework can be extended to FlexiBERT 2.0 by targeting a more granular design space. The FlexiBERT 2.0 framework enables us to model the latency, energy, and peak power draw of transformer architectures on a diverse set of embedded platforms.

### Hardware-Aware Neural Architecture Search

NAS techniques search for the architecture with the best accuracy in a specified dataset. However, NAS alone is hardly practical if we cannot run the best-performing transformer on the hardware at hand (or it does not meet hardware performance constraints). Recent state-of-the-art models, with billions of model parameters, exacerbate this problem [4]. Hence, recent works have focused on hardware-aware NAS, directed at architecture search for a target platform. For example, ChamNet proposed accuracy and resource (latency and energy) predictors and leveraged GPR-based Bayesian optimization (GPR-BO) to find the optimal CNN architecture for a given platform. Some works have proposed co-design of hardware and software design decisions. However, they are limited to CNN design spaces.

HAT, a recent framework for hardware-aware NAS for transformers, trains a large transformer model first and then uses latency feedback to obtain a sub-model for the given hardware platform. However, all sub-models are homogeneous (in terms of attention type) and have constant dimensionality in each encoder layer, limiting their representation capacity. Further, this disclosure uses a static training recipe, which may not be optimal for every sub-model. Lastly, as recent works have shown, its design space is highly restricted. Instead, one can leverage other NAS techniques for superior and efficient search of the optimal model in a diverse set of transformer architectures.

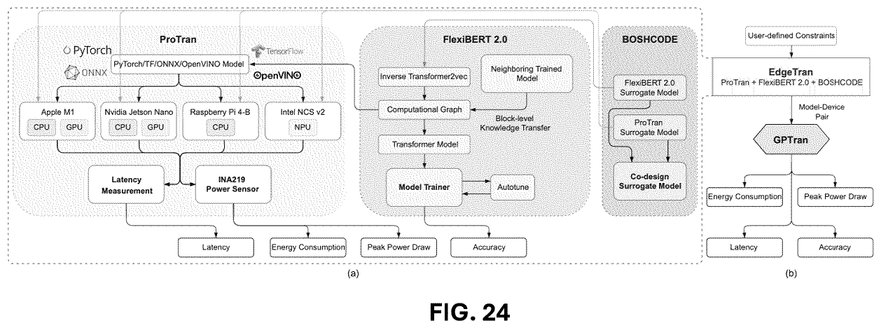

FIG. 24 (a) shows how ProTran leverages the proposed FlexiBERT 2.0 framework to obtain various hardware performance measures for diverse architectures. First, each queried model is converted in the FlexiBERT 2.0 design space to a computational graph that is trained (while also autotuning the training recipe to improve accuracy further). FlexiBERT 2.0 supports a range of deep learning frameworks, including PyTorch, TensorFlow, ONNX, and OpenVINO. Thus, one can profile any new hardware supported by any of these frameworks.

This model is then passed to the ProTran framework that runs inference for different NLP tasks on diverse mobile platforms. These platforms include Apple M1 with both a central processing unit (CPU) and an embedded graphics processing unit (GPU), Raspberry Pi embedded CPU, Intel Neural Compute Stick (NCS) v2 that has an embedded neural processing unit (NPU), and the Nvidia Jetson Nano (that has a CPU and an embedded GPU). We provide more details on the selected set of mobile platforms along with server-side baselines in Section IV-B1. ProTran then outputs the latency, energy consumption, and peak power draw of the given transformer model that EdgeTran can use for hardware-aware NAS and co-design. Next, BOSHCODE queries the FlexiBERT 2.0 and ProTran frameworks to create surrogate models for model accuracy and hardware performance (latency, energy consumption, and peak power draw) for the selected set of hardware platforms. These surrogate models are trained as a pre-processing step so that one does not have to train or run inference on the target hardware multiple times. This enables faster search using lightweight surrogate models.

In FIG. 24 (b), one can see EdgeTran, which exploits surrogate models obtained from ProTran and FlexiBERT 2.0. It runs co-design using the BOSHCODE framework to output an optimal model-device pair for the set of user-defined constraints. Finally, this pair is input to the GPTran post-processing step to optimize the transformer model further and improve performance.

### Latency and Energy Profiling of Transformer Models

Model latency is evaluated when running a batch of input with a given transformer model architecture. Wang et al. measure the latency of transformer inference on the Pixel 4 smartphone. However, the inference latency on certain edge devices can go up to hundreds of seconds. Thus, there is a need for a lightweight surrogate model that can quickly predict model inference latency (in a few milliseconds). This surrogate model is trained for latency, energy, and peak power estimation of diverse models in the FlexiBERT 2.0 design space using the proposed ProTran framework.

Energy consumption profiling of a machine learning (ML) model is challenging. This is because extracting the energy consumed only by training or running inference processes for an ML model is nontrivial. Further, when the design space is enormous, running training or inference for each model may incur drastically long runtimes. Nevertheless, previous works have profiled the energy consumption of ML architectures. For example, ChamNet trains energy predictors for various CNNs in its design space on different hardware platforms un-der various latency constraints. FTRANS obtains energy and power consumption for different transformer architectures on an FPGA. Some works have attempted to co-optimize hardware and transformer, however, under a very limited scope. These works prune the weights of a given model to reduce model complexity. However, the total model size remains significant. This calls for a rigorous search of inherently dense but smaller architectures that one could run on the device with a minimal memory footprint. This search falls under the domain of hardware-aware NAS. However, to the best of our knowledge, no transformer NAS approach has simultaneously accounted for accuracy, latency, energy consumption, and peak power draw. Thus, there is a need for lightweight surrogate models for the estimation of these measures on a diverse set of transformer architectures for various edge-AI platforms. This would enable energy-aware NAS of transformer models and efficient co-design for optimal edge deployments. Finally, this can be extended to search for optimal transformer-accelerator pairs.

Here, FlexiBERT 2.0 extensions are first presented relative to its predecessor. The ProTran pipeline is also disclosed for measuring hardware performance on diverse edge-AI platforms. The BOSHCODE co-design method is then presented. Finally, details on the proposed GPTran framework are given for optimizing transformer architectures.

### FlexiBERT 2.0 Framework

### 1) Design Space:

The traditional BERT model consists of multiple layers, each containing a bidirectional multi-headed self-attention (SA) module followed by a feed-forward module (that implements a fully-connected neural network with a single hidden layer). Searching over a space of BERT-like homogeneous models results in marginal gains. However, as proposed by Tuli et al., the design space of heterogeneous transformer architectures is immense because one can add a diverse set of operations to them. Such scale and diversity enable a rigorous search for the best-performing model resulting in significant gains over traditional search spaces. Due to these advantages, the expansive, heterogeneous, yet modular FlexiBERT architectures are leveraged in the disclosed design space. Several modifications are proposed to the original BERT encoder layer, primarily to the attention module.

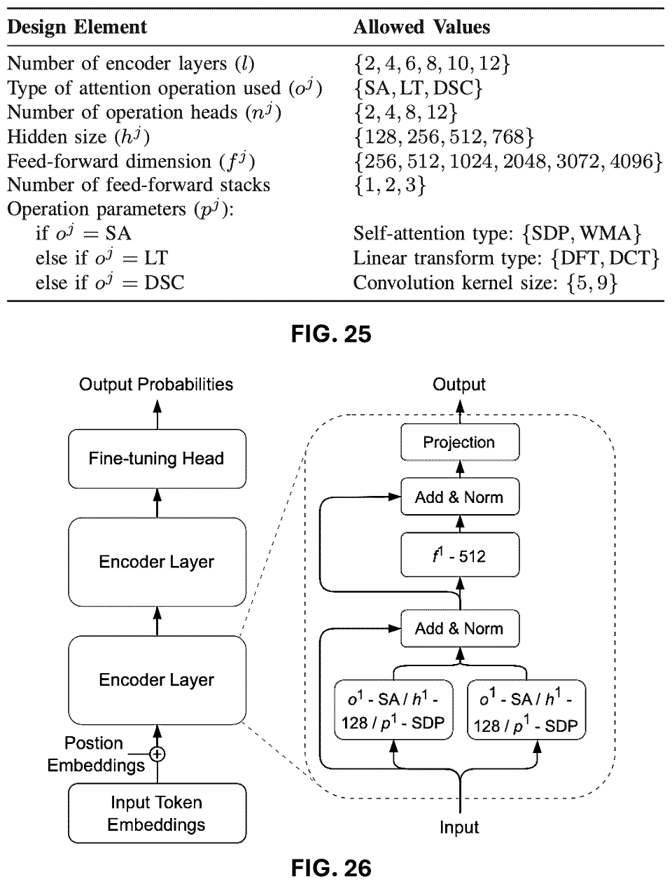

Weighted multiplicative attention (WMA)-based self-attention is considered in addition to scaled dot-product (SDP)-based self-attention. Linear transform (LT)-based attention is incorporated in FNet and dynamic-span-based convolution (DSC) in ConvBERT, in place of the vanilla self-attention mechanism. Whereas the original FNet implementation uses discrete Fourier transform (DFT), discrete cosine transform (DCT) are considered in the disclosed design space. Variable kernel sizes are allowed for convolution-based attention. Consolidating different attention module types (also called operations) that vary in their computational costs into a single design space enables the models to have inter-layer variance in expression capacity. Inspired by MobileBERT, architectures with multiple fully-connected layers are considered (this may be referred to as a feed-forward stack). The entire design space may be summarized with the range for each operation type in Table VII (FIG. 25). Considering all the possible hyperparameter values given in Table VII, a design space is generated with 1.69×10⁸⁸ architectures, much larger than those in any previous work. FIG. 26 shows how the BERT-Tiny model can be represented in the disclosed design space.

Unlike the original FlexiBERT design space, FlexiBERT 2.0 uses a broader range of values for each hyperparameter to target even more diverse architectures. This results in models that are substantially different from traditional BERT-like ones. Further, the architectures in the FlexiBERT 2.0 pipeline are made even more heterogeneous, i.e., instead of all attention operations in an encoder layer being the same, it allows an encoder layer to have different types of operations. For instance, where the original FlexiBERT only allows SA heads in an encoder layer, the disclosed design space also allows other attention types (from WMA, DCT, DFT, DSC) in the same layer. Each attention head is also allowed a different hidden dimension.

### 2) Weight Transfer:

To obtain the accuracy of a new model (queried by the active learning framework to train the surrogate model), training it from scratch would be computationally expensive. FlexiBERT implements weight transfer at the ‘encoder-level’ so that queried models are not trained from scratch. It transfers weights from a neighboring pre-trained model. This speeds up the training of queried models. In the disclosed framework, not only is weight transfer leveraged to train the surrogate model quickly but also for training new models while implementing the GPTran pipeline.

The original FlexiBERT's weight transfer is updated to an ‘attention-head level,’ i.e., the entire encoder layer hyperparameters are not required to be the same for transferring the weights. If some of the attention heads are alike in two neighboring models, the weights for those attention heads can be directly transferred. When attention heads have different dimensions but the rest of the parameters are the same, one can implement weight transfer by cloning an ordered part of the weight matrix (this may be referred to as ordered transfer (OT)) or by random projection (RP) of the original weight matrix to the new dimension. RP takes inspiration from dimensionality reduction techniques based on the Johnson-Lindenstrauss lemma. To implement RP, one can project the original input space on a randomly generated matrix. Its components are drawn from a Gaussian distribution [symbol] (0, 1/n_{c}), where n_{c} is the number of components or the dimensionality of the target space. This method decreases the loss of information when transferring weights to a lower dimension, reducing the number of iterations to train the new neighbor. This, in turn, lowers the net training time of all queries, reducing the overall search time.

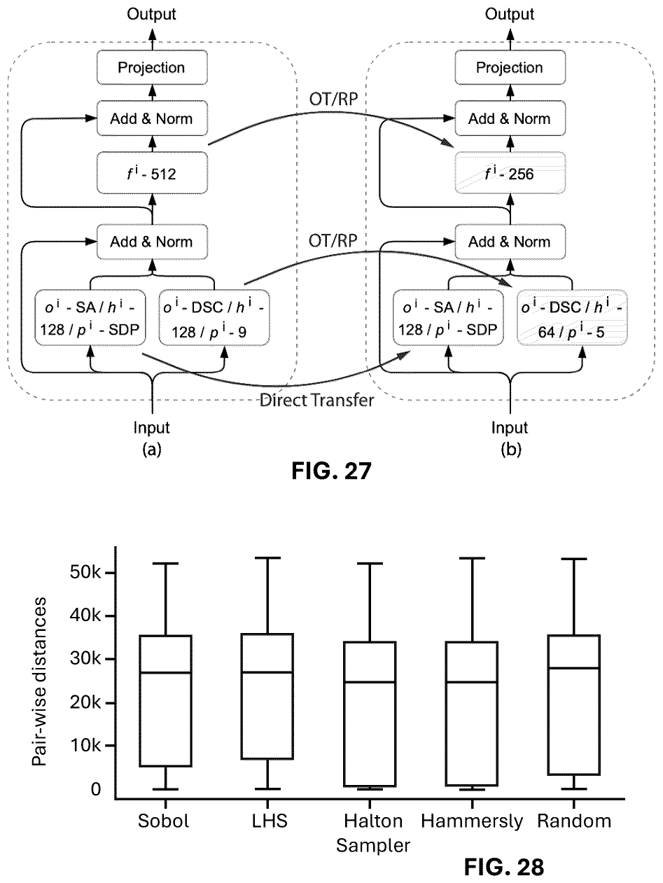

FIG. 27 summarizes the weight transfer process in FlexiBERT 2.0 for two neighboring models.

### 3) Support for Model Formats:

To enable profiling on diverse edge-AI platforms, FlexiBERT 2.0 supports various ML frameworks. All models in the FlexiBERT 2.0 design space can be saved in PyTorch, Tensorflow, ONNX, and OpenVINO formats. This broadens the scope of our proposed models to a wide range of platforms, enabling unified benchmarking and wider deployments.

### 4) Transformer Embeddings:

The original FlexiBERT pipeline leverages a Transformer2vec embedding scheme to form dense embeddings for the transformer architectures in the design space. However, training these embeddings is computationally expensive. Thus, proposed is an embedding scheme that does not require training. This scheme is illustrated next.

For the selected ranges of hyperparameters in our design space (see Table VII, FIG. 25), 37-dimensional embeddings are generated as follows:

The first entry in the embedding is the number of encoder layers (l) in the current transformer model. In other words, for the embedding of a transformer architecture e, e₁ represents the number of encoder layers in the architecture.

For an encoder layer j, e₂₊₃₍ⱼ₋₁₎ represents the hidden dimension (h^{j}). This is the sum of the hidden dimension for each attention head in that encoder layer. Other embedding indices determine how much h^{j} are allocated to each attention head.

For an encoder layer j, e₃₊₃₍ⱼ₋₁₎ represents the index of the feed-forward operation formed by the range of feed-forward layers possible in the given design space. For the six possible hidden dimensions in the feed-forward layers (see Table VII), there can be a stack of up to three layers, thus giving rise to 258 feed-forward operation types for every encoder layer.

For an encoder layer j, e₄₊₃₍ⱼ₋₁₎ represents the index of the attention head operation in the list of multi-head operations types. This list is obtained based on the number of attention heads selected for that encoder layer, the type of each attention head, the hidden dimension for each attention head, and their respective combinations with replacement.

For models less than 12 layers deep, the respective entries in their embeddings are set to zero. Although these embeddings are sparse, they are much faster to obtain than training with the Transformer2vec embeddings. This is especially important due to the much larger design space of the proposed framework.

### The ProTran Framework

The ProTran framework that leverages the FlexiBERT 2.0 design space to train surrogate models for latency, energy consumption, and peak power draw on diverse platforms is now described. The surrogate models are trained in an active-learning fashion. An initial set of diverse samples are first obtained to initialize the surrogate model. Then, the uncertainty estimates from that model are used to query new architectures until the maximum uncertainty falls below a threshold.

### 1) Initial Sampling:

Any regressor used for an active-learning pipeline requires an initial seed dataset to predict further queries it needs to explore. Intuitively, this dataset should be as representative of the design space as possible. For this, we test various low-discrepancy sequence sampling strategies. FIG. 28 shows a boxplot of pairwise distances between embeddings using various sampling methods, namely, Sobol sampling, Latin hypercube sampling (LHS), Halton sampling, Hammersly sampling, and Random sampling. The LHS method is used here since it results in the highest first quartile of pairwise distances between the embeddings of the sampled architectures. In other words, it maximizes the probability of having divergent points in the sampled set.

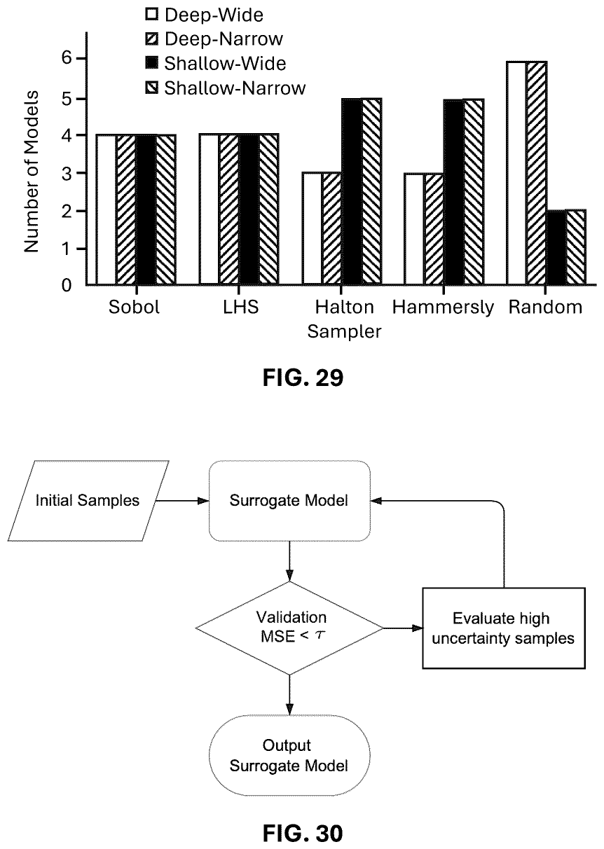

16 samples are obtained using the chosen method to initialize the seed dataset. To further test for sample diversity, we segregate the sampled models into four categories: deep-wide, deep-narrow, shallow-wide, and shallow-narrow. The model is shallow if the number of encoder layers is strictly less than eight and deep otherwise. The model is narrow if the median number of attention heads is strictly less than eight and wide otherwise. FIG. 29 shows the number of each model type obtained using each sampling scheme with 16 initial samples. Sobol and LHS methods have equidistribution of model types, demonstrating high diversity relative to other schemes.

### 2) Learning the Performance Predictor:

Once the initial samples are evaluated for all the hardware performance measures on a given edge-AI platform, a performance predictor is needed that takes the transformer embedding as input and predicts each measure under an error constraint. One can eventually leverage this predictor, also called a surrogate model, along with a corresponding uncertainty estimation, to query novel models in the design space. This further increases confidence in estimation (i.e., lowers the uncertainty or validation error).

This strategy is employed in an active-learning fashion to minimize the number of queried models for evaluation. Here, validation error refers to the error of the predictor on untrained samples. FIG. 30 shows a flowchart of this pipeline. The initial 16 LHS-sampled transformer architectures are used to initialize the surrogate model. High-uncertainty samples are then evaluated to train the surrogate model iteratively on the expanding dataset until the validation mean-squared error (MSE) falls below a predetermined threshold.

For the active-learning loop, several regression schemes, i.e., surrogate models, are experimented with, namely linear regression (LR), GPR, support-vector regression (SVR), DT, BDT, gradient-boosted decision trees (GBDT), and BOSHNAS that exploits gradient-based optimization using back-propagation to the input and heteroscedastic modeling. These models are employed to minimize the overall uncertainty in estimating the prediction measures. GPR and BOSHNAS directly indicate the epistemic uncertainty in predictions; thus, they select the following query in the active-learning loop as the model with the highest uncertainty. The uncertainty in estimation for BDT and GBDT are computed as the standard deviation in the predictions of each decision tree for every output hardware performance measure. However, LR, DT, and SVR cannot model uncertainty in performance prediction. In such cases, random samples are evaluated to expand the dataset.

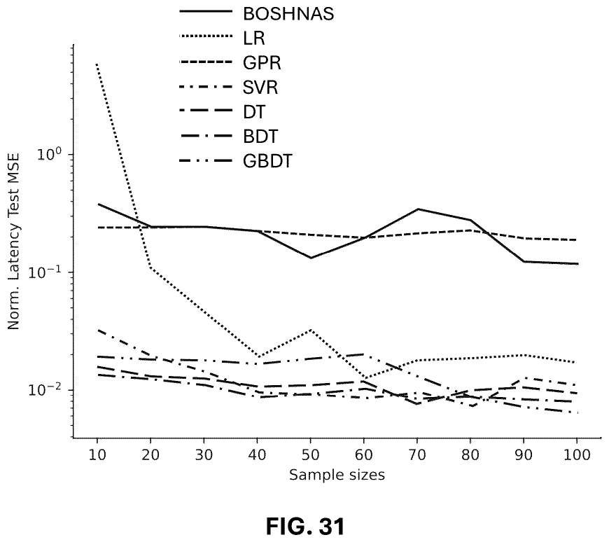

These regressors are tested to model the inference latency on the Nvidia A100 GPU for the SST-2 task in the GLUE benchmarking suite. For a pool of high-uncertainty samples evaluated at each iteration, one can take smaller subsets of train/validation (80-20%) splits to check the prediction MSE on the validation set after training the regressor on the training set. From FIG. 31, one can see that GBDT reaches the lowest prediction error on the validation set as the sample size is increased. BOSHNAS does not perform well due to the high sample sizes required to train neural network surrogates optimally. Thus, GBDT is chosen as the surrogate model in the active-learning loop while training performance predictors for all platforms.

Table VIII, below, shows the sample sizes required for GBDT to converge for different platforms.

TABLE VIII
Selected batch size and the number of samples
for convergence for different platforms.

| Platform | Batch Size | Number of Samples |
|---|---|---|
| Nvidia A100 GPU | 128 | 239 |
| Apple M1 CPU | 32 | 104 |
| Apple M1 GPU | 32 | 92 |
| Raspberry Pi CPU | 1 | 81 |
| Intel NCS NPU | 1 | 21 |
| Nvidia Jetson Nano CPU | 1 | 223 |
| Nvidia Jetson Nano GPU | 1 | 22 |

Convergence is reached when the validation MSE falls below 0.5% for latency, energy, and peak power draw, individually, when normalized (e.g., dividing the latency values by the maximum latency encountered in the dataset in order to obtain normalized values between 0 and 1).

The predicted latency of 32 sampled transformer models obtained using the GBDT regressor can be compared against the real latency on the Nvidia A100 GPU. The predicted latency is extremely close to the real latency.

### BOSHCODE

BOSHNAS is a NAS technique that runs gradient-based optimization using backpropagation to the input (GOBI) on a single and lightweight neural network (NN) model that predicts not only model performance, but also the epistemic and aleatoric uncertainties. It leverages an active-learning framework to optimize the upper confidence bound (UCB) estimate of model performance in the embedding space. Estimates of aleatoric uncertainty enable further optimization of the training recipe for every model in the design space. GOBI freezes the model weights and backpropagates the gradients towards the input values to minimize the output optimization measure. The application of BOSHNAS is extended to BOSHCODE, a co-design framework for transformer models and edge-AI devices. This framework is described next.

### 1) Uncertainty Types:

Prediction uncertainty can arise from not only the approximations in the surrogate modeling process but also parameter initializations and variations in model performance due to different training recipes. They are referred to as epistemic and aleatoric uncertainty, respectively.

### 2) Surrogate Model:

Following the surrogate modeling approach used in CODEBench, a co-design method for CNNs and accelerators, we model the performance and the aleatoric uncertainty using a natural parameter network (NPN) ƒ(x_{TXF}, x_{ED}; θ). The epistemic uncertainty is modeled using g(x_{TXF}, x_{ED}; θ′). and g(x_{TXF}, x_{ED}; θ″). GOBI is leveraged on h, a student network for the teacher g, to avoid numerical gradients due to their poor performance. Here, x_{TXF} refers to the transformer embedding and x_{ED} refers to the embedding for the edge device (θ, θ′, and θ″ refer to the training parameters of the models). (μ, σ)←ƒ(x_{TXF}, x_{ED}; θ), where μ is the predicted mean performance and a is the aleatoric uncertainty. Moreover, h predicts a surrogate (\hat{ξ}) of the epistemic uncertainty (ξ).

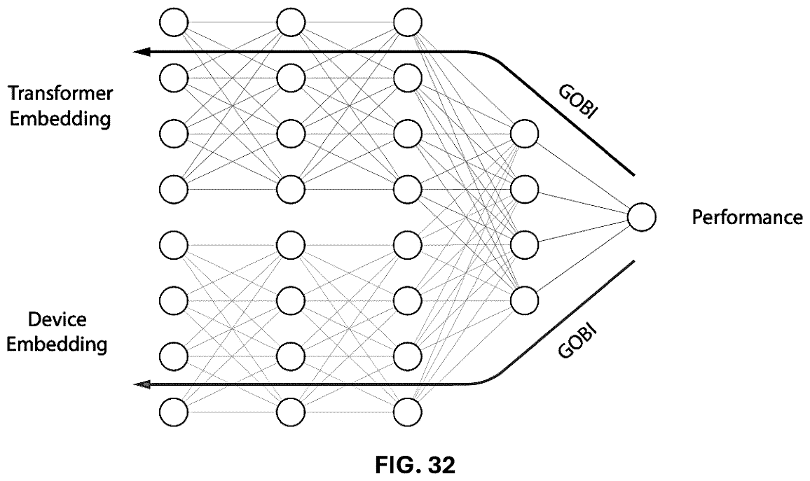

FIG. 32 shows a simplified schematic of the teacher network g in BOSHCODE. It realizes the model-device embeddings, a combination of the 37-dimensional transformer embeddings and 7-dimensional one-hot device encodings. GOBI is run on the combined and separate representations (of the student network h) to find the optimal model-device pair that maximizes the UCB estimate of the performance (P). Here, performance refers to a convex combination of model accuracy and hardware performance measures (latency, energy, and peak power consumption). Mathematically,

$$Performance ( P ) = α \times Accuracy + β \times ( 1 - Energy Consumption ) + γ \times ( 1 - Peak Power Draw ) + ε \times ( 1 - Latency ) \qquad ( 1 )$$

where α+β+γ+ε=1 are hyperparameters. The values of the individual performance measures are normalized with respect to their maximum values (thus these values reside in the [0, 1] interval). For different applications, the user can define constraints based on the values of these hyperparameters. For instance, if accuracy is of utmost importance, a can be set high. On the other hand, in real-time machine translation applications that require low latency, F can be set high.

### 3) Active Learning and Optimization:

In a design space of model-device pairs A, one can search for the predicted best-performing pairs in an active-learning fashion. Assuming one has the three networks f, g, and h initialized based on a randomly sampled set of model-device pairs (δ), one can run second-order optimization on UCB=u+k₁·σ+k₂·\hat{ξ}, where x_{TXF}, x_{ED}∈Δ, k₁, and k₂ are hyperparameters.

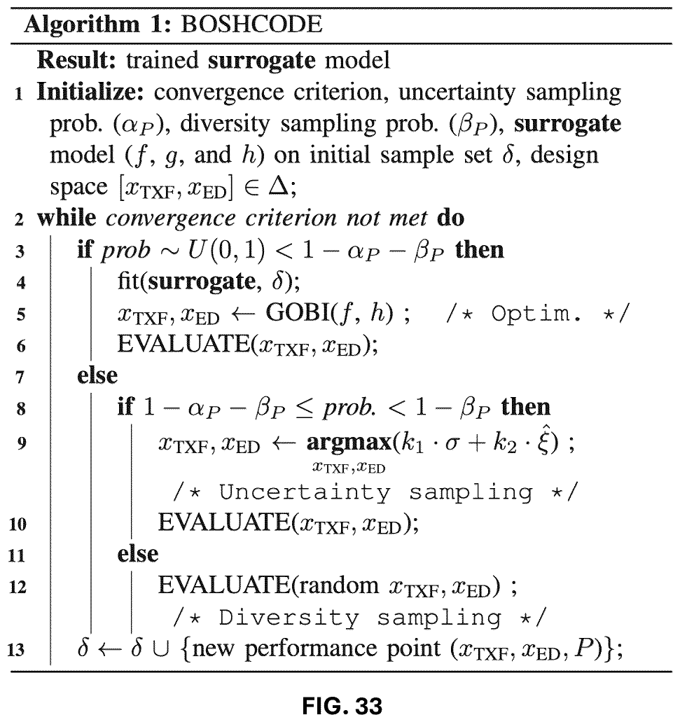

Algorithm 1 (FIG. 33) summarizes the above process. Starting from an initial sample set 6, one can run until convergence the following steps. To trade off between exploration and exploitation, two probabilities are considered: uncertainty-based exploration (αP) and diversity-based exploration (βP). With probability 1−α_{P}−β_{P}, one can run second-order GOBI using the surrogate model to optimize UCB. Adding the converged point (x, o) in δ, one can train the surrogate models (line 4 in Algorithm 1). One can then generate a new query point (using GOBI), transfer weights from neighboring models, and train it (or use a pre-trained surrogate) through the EVALUATE function (lines 5-6). With α_{P} probability, one can sample the search space using the combination of aleatoric and epistemic uncertainties to find a point where the performance estimate is uncertain (line 10). To avoid getting stuck in a localized search subset, one can also choose a random point with probability β_{P} (line 12). The EVALUATE function gives the performance measure P for the given pair (x_{TXF}, x_{ED}) using the ProTran and FlexiBERT 2.0 frameworks or their corresponding surrogates.

### The GPTran Framework

Once EdgeTran obtains the best pair of transformer model and edge device, GPTran nudges the architectural parameters of the converged transformer architecture to improve performance further. Unlike BOSHCODE, which globally searches for the best-performing architecture, GPTran is a local search post-processing technique. Its operation takes inspiration from the lottery ticket hypothesis, where a part of the network is usually sufficient to obtain the same performance as the parent network. In this case, GPTran also helps overcome inaccuracies in surrogate modeling that may lead the co-design framework to a model that is close to but not precisely optimal. However, unlike previous works on structural adaptation at the level of individual neurons or convolutional filters (for CNNs), one can run the grow-and-prune framework at the compute-block level due to the modularity of the FlexiBERT 2.0 design space.

GPTran runs gradient-based (along with random) growth and magnitude-based pruning at the block level for transformer architectures. It involves multiple iterations of interleaved grow-and-prune steps. These steps are described next.

The grow step: For a given parent model, n_{G} child models are instantiated with the net number of parameters slightly higher than that of the parent. Here, either of two types of growth strategies may be employed:

Grow attention head (G_{A}): An attention head (chosen from a set A_{TXF}) is added to a particular encoder based on two scenarios with equal probability. One can either add an attention head next to the one with the highest (or the next highest) gradient or at random. Here, one can add n_{A}^{G} operation blocks. As expected, one can also increase the hidden dimension h^{j} for the selected layer by the hidden dimension of the added attention head since the net hidden dimension of an encoder layer is a sum of those for each attention head.

Grow feed-forward stack (GFF): One can add a fully-connected layer to the stack, in the feed-forward module, with min(h_{F}, h_{F}^{G}) neurons, where h_{F} is the number of neurons in the last hidden layer in the selected feed-forward module and h_{F}^{G} is a predetermined hyperparameter. Again, one can select the feed-forward module based on the gradient or randomly, each with equal probability.

One can generate all the n_{G} children based on the current growth mode (either G_{A} or G_{FF}).

The prune step: For a given parent model, one can instantiate a child model (number of children n_{P}=1) with the net number of parameters slightly lower than that of the parent. For this, one can employ either of the following two pruning strategies:

Prune attention head (P_{A}): One can remove n_{A}^{P} attention heads based on their average magnitude of weights. For instance, for a WMA head, one can obtain an average of all weight matrices (i.e., key, query, value, output, and the WMA matrices). If the average of the weights for this head is the lowest among all heads in the current model, one can prune it out from the child model (which was initially a replica of the parent). Again, one can also reduce the hidden dimension h^{j} of the selected layers by the hidden dimensions of the attention heads removed.

Prune feed-forward layer (P_{FF}): One can prune a fully-connected layer based on the average weights of the fully-connected layers in all feed-forward modules. One can prune the selected layer to min(h_{F}^{P}, h_{F}−h_{F}^{P}) number of neurons, where h_{F} is the number of neurons in the selected hidden layer and h_{F}^{P} is a predetermined hyperparameter.

One can prune the selected model based on the current pruning mode (either P_{A} or P_{FF}) employing either of the above strategies.

To search for compact models from the current converged 21 model obtained using BOSHCODE, one can set n_{P} to be higher than n. To minimize the number of training steps for every child node and leverage the neighboring (and already trained) parent node, one can transfer the weights via the RP or OT method. Due to the high overlap ratio (between the parent and the child) and highly granular weight transfer in FlexiBERT 2.0, one can train individual child models rapidly. This significantly reduces search time.

For GPTran, the optimization metric is the pre-training loss. Unlike some previous works, one can employ block-level growth and pruning during pre-training rather than during fine-tuning. Thus, the optimization metric is the pre-training loss (or the model's perplexity on language data) while executing local search. One can implement GPTran in a cycle of four modes (MGP) in the following order: G_{A}, G_{FF}, P_{A}, P_{FF}. One can cycle through the grow/prune modes at every tree depth until we reach the best-performing architecture (i.e., one whose children perform worse than that node).

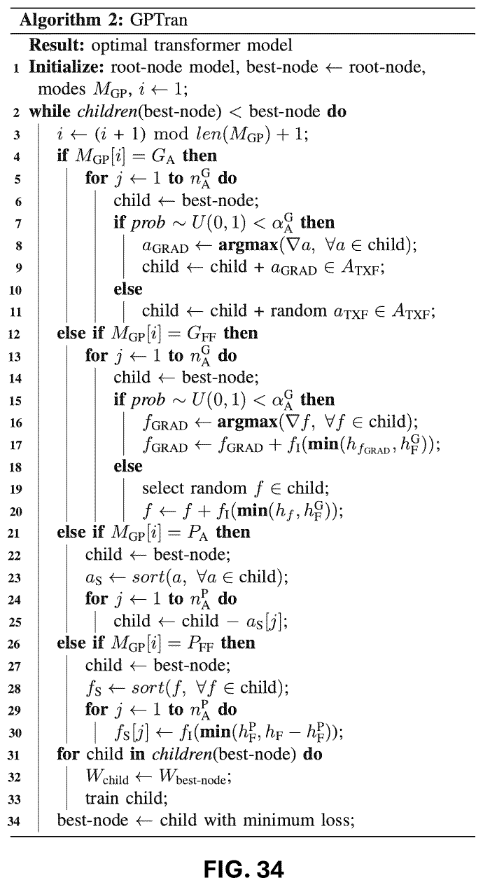

Algorithm 2 (FIG. 34) summarizes the GPTran algorithm. It stops at the best-performing model. It starts with the converged transformer model obtained using BOSHCODE. Then, it cycles through the four modes presented above. For G_{A}, it creates n_{A}^{G} child models based on the attention head with the maximum gradient during training (line 8) or a randomly selected attention head (line 11). For G_{FF}, it grows a feed-forward stack based on the one with the highest gradient during training (line 16) or a randomly selected layer (line 19). Here, function η₁( ) refers to the instantiation of a new fully-connected layer with the hidden dimension as input. For P_{A}, it removes the attention heads with the n_{A}^{P} smallest average weight magnitudes. For P_{FF}, it prunes feed-forward layers with n_{A}^{P} smallest average weight magnitudes by a given factor. Finally, one can transfer weights from the parent node to the instantiated children before training them (line 32). Here, weight transfer is implemented through OT or RP. Note that one can randomly instantiate the weights of all newly added attention heads or layers.

GPTran may also implement backtracking (not shown in Algorithm 2) when a current best-performing leaf node does not give the overall best pre-training loss. In the hierarchical tree data structure formed during search, if the currently reached leaf does not have the best performance (or the lowest pre-training loss), GPTran backtracks to the node with the next-best performance that has unexplored children. It then populates the tree from there.

### FlexiBERT 2.0 Design Space

Table VII shows the range of hyperparameter values in the proposed FlexiBERT 2.0 design space. This expanded range for each hyperparameter increases the number of possible transformer models from 3.3×10⁹ in the original FlexiBERT framework to 1.7×10⁸⁸. A large design space leads to better-performing models, which motivates this expansion.

### 1) Hyperparameter Combinations:

Next, the process of obtaining the many architectures in the design space is illustrated.
Different feed-forward hidden dimensions are possible (6 values as per Table VII). One can stack these feed-forward operations with 1, 2, or 3 hidden layers. Thus, the number of feed-forward operation types=6+6²+6³=258.
There are 7 possible attention operations in A_{TXF}, namely: SA-SDP, SA-WMA, LT-DFT, LT-DCT, DSC-5, DSC-9, and DSC-13. Thus, the number of multi-head attention operation types possible for each

$$encoder layer ( without considering the hidden dimension ) = {\sum }_{i ∈ {n}_{A}} ( \begin{matrix}7 + i - 1 \\ i\end{matrix} )$$

(for n_{A}={2, 4, 6, 8, 10, 12} attention heads each)=21805. Note that combinations with replacement was used, i.e.,

$$( \begin{matrix}n + i - 1 \\ i\end{matrix} ) ,$$

and not product, i.e., n, since that would add isomorphic redundancy to every encoder layer.
Now, for every encoder layer, one needs to determine the feed-forward operations, hidden dimension, and multi-head attention operation, leading to z_{i∈n}_{_{A}} 258ⁱ×4ⁱ×21805ⁱ=1.7×10⁸⁸ transformer models.

### 2) Model Training:

One can pre-train the models with a combination of publicly available text corpora, viz. BookCorpus (BookC), Wikipedia English (Wiki), OpenWebText (OWT), and CC-News (CCN). In some examples, for simplicity, most training hyperparameters were borrowed from RoBERTa for robust training of diverse architectures in the design space. One can set the batch size to 256 and warm up the learning rate over the first 10,000 steps to its peak value at 1×10⁻⁴ that then decays linearly. In one example, one can set the weight decay to 0.01, Adam scheduler's parameters β₁=0.9, β₂=0.98 (shown to improve stability), ε=1×10⁻⁶, and run pre-training for 1,000,000 steps.

One can fine-tune the models on the nine GLUE tasks. One can also run automatic hyperparameter tuning in the fine-tuning process (i.e., search the training recipe) using the tree-structured Parzen estimator algorithm. In one example, the learning rate was randomly selected logarithmically in the [2×10⁻⁵, 5×10⁻⁴] range and batch size in {16, 32, 64} uniformly. Table IX, below, shows the best training recipe for fine-tuning ET (edge device and transformer co-design model obtain from BOSHCODE in one example) on each GLUE task selected using this autotuning technique.

TABLE IX
Hyperparameters used for fine-tuning ET on GLUE tasks

| Task | Learning Rate | Batch Size |
|---|---|---|
| CoLA | 2.0 × 10⁻⁴ | 64 |
| MNLI | 9.4 × 10⁻⁵ | 64 |
| MRPC | 2.23 × 10⁻⁵ | 32 |
| QNLI | 5.03 × 10⁻⁵ | 128 |
| QQP | 3.7 × 10⁻⁴ | 64 |
| RTE | 1.9 × 10⁻⁴ | 128 |
| SST-2 | 1.2 × 10⁻⁴ | 128 |
| STS-B | 7.0 × 10⁻⁵ | 32 |
| WNLI | 4.0 × 10⁻⁵ | 128 |

This hyperparameter optimization uses random initialization each time. This results in variation in performance each time one queries the model (otherwise called the aleatoric uncertainty). For tasks MRPC, RTE, and STS-B, one can use the fine-tuned checkpoint from MNLI training instead of the pre-trained model.

All models were trained on NVIDIA A100 GPUs and 2.6 GHz AMD EPYC Rome processors. The entire process of training the 16 LHS samples in the FlexiBERT 2.0 design space took around 100 GPU-days.

### 3) Surrogate Modeling:

To obtain a surrogate model for all transformer architectures in the FlexiBERT 2.0 design space, we employ a similar approach to ProTran. For the initial 16 LHS samples, different regressors were tested. However, while co-designing without hard constraints on model accuracy, a user may be interested in the best model from a sampled set instead of the one that barely meets the accuracy constraint. For this, one can also test a ranking regressor, LambdaMART, which represents a state-of-the-art in the learning-to-rank problem.

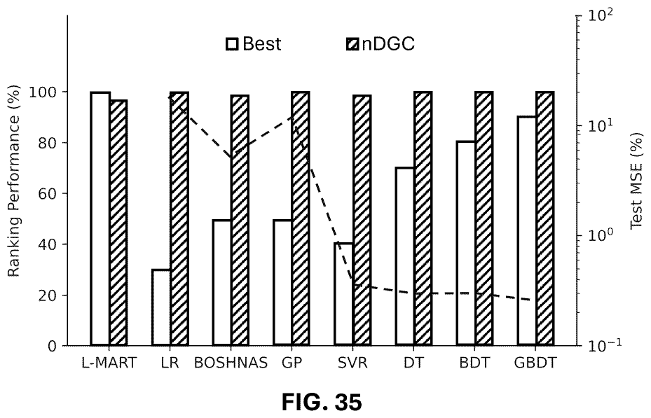

FIG. 35 compares different regressors based on ranking performance and MSE on the test set for the prediction of GLUE scores. One can take the first 11 models in the initial set of LHS samples as the training set and measure performance on the rest, i.e., the test set. One can compare ranking performance based on two tests. First, we assemble all models in the training set into groups of three (resulting in 5 combinations 3 in the test set). Then, one can compare the best model by taking the actual best model among the set of five and the predicted best model by sorting the models based on their predicted GLUE scores. One can also compare a commonly used ranking metric, the normalized discounted cumulative gain (nDCG). For this, one can discount subsequent ranks logarithmically. Finally, one can compare the absolute MSE for the predicted GLUE scores on the test set. Although LambdaMART (L-MART) has a high ranking performance, GBDT shows reasonably high ranking performance and low test MSE (0.3%). Hence, one can use the GBDT surrogate model for performance prediction in our design space.

### Hardware Performance Measurements

### 1) Hardware Platforms:

One can now present details of the hardware platforms that form the test bed for several experiments. The baseline server platform considered is the Nvidia A100 GPU with 40 GB video random-access memory (VRAM). The mobile platforms include the Apple M1 ARM SoC with an 8-core CPU, 8-core GPU, and 16 GB unified memory on an iPad (for ease of experimentation, experiments were performed on a MacBook Pro that has the same SoC), Raspberry Pi 4 Model-B that has the Broadcom BCM2711 ARM SoC, Intel Neural Compute Stick v2 with its NPU, and, finally, an Nvidia Jetson Nano with an Nvidia Tegra X1 ARM SoC that has a CPU, an embedded GPU, and 2 GB unified memory.

### 2) Power Measurements:

An INA219 sensor was used, connected via the I2C interface to Raspberry Pi, for energy and power measurements of the Raspberry Pi, Nvidia Jetson Nano, and the Intel Neural Compute Stick. The sensor measures real-time power drawn by the device power supply. Thus, the measurement corresponds to the net energy consumed by the hardware platform. For the Nvidia A100 GPU, the nvidia-smi command was used to measure GPU power draw. For the Apple M1 processor, the CPU/GPU power was measured via the powermetrics command. These commands measure the power drawn by the power supply of the respective hardware modules.

All measurements of hardware performance were performed while running inference on the GLUE tasks (multiple times). The geometric mean was then taken of the evaluated performance measures and the surrogate models were trained with these mean profiles.

### Co-Design Pipeline

To run BOSHCODE, the following parameter values were used to obtain the net performance measure: α=0.5, β=0.2, γ=0.2, ε=0.1 (Eq.1). α_{P} and β_{P} were set to 0.1 each, and k₁ and k₂ were set to 0.5 each. For all three surrogate models f, g, and h, the input embeddings of the transformer model and edge device (x_{TXF} and x_{ED}, respectively) were passed to networks with two distinct hidden layers with 32 hidden neurons each. The outputs of these two separate sub-networks were concatenated and passed through a fully-connected layer with 64 and then 32 neurons. Finally, the network ends with one output neuron to predict the performance measure.

All input embeddings obtained using GOBI for the surrogate models may not be valid. For instance, x_{ED} should be one-hot encoded. To add constraints to the optimization process, along with forcing the model to learn the performance only for valid input embeddings, a datapoint (x_{TXF}, x_{ED}, P_{MIN}) was added to the dataset δ if either of the input embeddings is invalid or does not adhere to input constraints. Another example of input constraint could be that transformers with only up to six layers are allowed. P_{MIN} has a very low value, set to −100 for several experiments.

### Grow-and-Prune Process Applied to ET

GPTran was applied to the optimal transformer model, i.e., ET, produced by BOSHCODE. Table X, below, summarizes the hyperparameters chosen for GPTran. Table XI, below, shows the training choices for each of the four modes. All hyperparameter values were found through grid search.

TABLE X
Hyperparameters used in GPTran.

| Hyperparameter | Value(s) |
|---|---|
| A_{TXF} | SA-SDF, SA-WMA, LT-DFT, |
| | LT-DCT, DSC-5, DSC-9, DSC-13 |
| n_{G} | 10 |
| n_{A}^{G} | 1 |
| h_{F}^{G} | 1024 |
| n_{P} | 1 |
| h_{A}^{P} | 2 |
| h_{F}^{P} | 128 |

TABLE XI
Training choices for different modes in GPTrain.

| Mode | Max. Learning Rate | Pre-training Steps |
|---|---|---|
| G_{A} | 1 × 10⁻⁵ | 20,000 |
| G_{FF} | 1 × 10⁻⁵ | 20,000 |
| P_{A} | 5 × 10⁻⁵ | 20,000 |
| P_{FF} | 1 × 10⁻⁵ | 10,000 |

We also disclose a dynamic training framework, called DynaProp, that speeds up the training process and reduces memory consumption. DynaProp is a low-overhead pruning method that prunes activations and gradients at runtime. To effectively execute this method on hardware for a diverse set of transformer architectures, we propose ELECTOR, a framework that simulates transformer inference and training on a design space of accelerators. We use this simulator in conjunction with the proposed co-design technique, called TransCODE, to obtain the best-performing models with high accuracy on the given task and minimize latency, energy consumption, and chip area. The obtained transformer-accelerator pair achieves 0.3% higher accuracy than the state-of-the-art pair while incurring 5.2× lower latency and 3.0× lower energy consumption.

In various aspects, also disclosed is TransCODE, a co-design framework for transformers and application-specific integrated circuit (ASIC)-based accelerators.

For efficient on-device training, we propose DynaProp, which dynamically prunes weights, activations, and gradients to skip ineffectual MAC operations and speed up the transformer training/inference process. DynaProp leverages specialized low-overhead hardware modules to induce sparsity into transformer training and inference.

To support vast design spaces involving flexible and heterogeneous transformer architectures, a flexible BERT accelerator (ELECTOR) framework is proposed. ELECTOR supports diverse transformer architectures within the FlexiBERT 2.0 design space. It efficiently implements model operations through dedicated hardware modules and a functional transformer mapper. The design space within the ELECTOR framework involves disparate accelerators that can execute the transformers in the FlexiBERT 2.0 design space. ELECTOR also effectively implements the proposed DynaProp algorithm to speed up transformer training and inference. It involves 14,850,000 accelerators, a design space much more extensive than investigated in any previous work.

The proposed ELECTOR and FlexiBERT 2.0 design spaces are then leveraged to implement co-design and obtain a transformer-accelerator pair that maximizes the performance objectives within the given user-defined constraints. This framework, which co-designs the transformer-accelerator pair, may be referred to as TransCODE. It leverages the best-performing optimization technique in the considered design spaces.

Next, background material is presented on popular transformer and accelerator architectures and the corresponding design decisions. Previously proposed hardware-software co-design methods are also discussed.

### Transformer Design Space

Previous works propose various transformer architectures. BERT is one of the most popular architectures that is widely used for language modeling. Its variants leverage mechanisms other than vanilla self-attention to optimize performance or reduce model size and complexity. They include RoBERTa that implements robust pre-training techniques, ConvBERT that uses one-dimensional convolutional operations, MobileBERT that employs bottleneck structures and multiple feed-forward stacks, among many others. Further, architectures like FNet and LinFormer use Fourier transform and low-rank approximation, respectively, of the self-attention operation to aid efficiency and reduce the number of model parameters.

In order to search for the best-performing model for a given task, FlexiBERT unifies and implements heterogeneous and flexible transformer architectures, encapsulating various self-attention operation types. Each encoder layer in its design space can have a different attention mechanism (heterogeneity) and a different hidden dimension (flexibility). Among many works that implement neural architecture search (NAS) in a design space of transformer models, FlexiBERT has the largest and the most expressive design space. This results in state-of-the-art models that outperform previous architectures in accuracy. FlexiBERT 2.0 (disclosed herein) extends the design space to 1.7×10⁸⁸ transformer models, the largest and the most expressive transformer design space to date. The FlexiBERT 2.0 design space is therefore used to implement co-design here. Note that no previously proposed accelerator supports heterogeneous and flexible transformer workflows. Traditional transformer accelerators are discussed next.

### Accelerator Design Space

A transformer model's hardware performance (characterized by latency, energy consumption, and chip area) on a given platform depends on multiple factors. These factors include memory size and bandwidth, number of MAC units (that can execute matrix multiplication operations in parallel), number of specialized hardware modules (e.g., ones for softmax and layer-norm operations), operation scheduling, dataflow, model sparsity, etc. These design decisions lead to many existing accelerators proposed in the literature.

A³ is one of the first ASICs to support transformer acceleration. It uses several approximation strategies to avoid computing attention scores that are close to zero. SpAtten proposes the top-k pruning algorithm that ranks input token and attention-head scores using a dedicated hardware module. However, it only considers part of the activations formed, not sparsity in all possible matrix multiplication operations. Further, implementing the proposed top-k pruning mechanism involves high compute overhead; its time complexity is [symbol] (N³), leading to marginal gains in energy efficiency. Energon approximates this pruning mechanism. However, since it is limited to being a co-processor, it requires high off-chip memory access. Finally, OPTIMUS targets sparsity in a broader scope, using a set-associative rearranged compressed sparse column format to eliminate ineffectual MAC operations, although limited to weight matrices. Here, weights correspond to the trainable transformer model parameters and activations are represented by intermediate matrices formed by the transformer model operations.

To overcome the drawbacks of the abovementioned accelerators, AccelTran (disclosed herein) implements dynamic inference with a transformer while pruning all weights and activations. In addition, it leverages matrix tiling to improve parallelization and resource utilization. However, it only executes transformer inference and not training, uses a fixed set of design choices (e.g., a fixed tile size, number of PEs, buffer sizes), and does not support diverse models, thus leading to sub-optimal utilization. To tackle this problem, various works propose design spaces of transformer accelerators to efficiently obtain the optimal transformer architecture for the given task. However, such design spaces are limited to off-the-shelf FPGAs that only focus on inference. Previous works on co-design of the AI model and hardware accelerator will now be discussed.

### Hardware-Software Co-Design

Various works target CNN-accelerator co-design. CODEBench searches over massive CNN and accelerator design spaces. However, its accelerators are geared toward CNN workflows and thus inefficient for transformer pipelines. As discussed before, Qi et al. use an RNN and RL-based controller to guide search in a pool of five FPGAs and adjust the pruning parameters of an input transformer model. However, they only consider latency and accuracy constraints and do not optimize energy consumption and chip area. Peng et al. explore the scheduling and sparsity decisions on an FPGA and adapt the input sequence length. SpAtten implements hardware-aware NAS (HW-NAS), where it finds a sub-net of a trained super-net. However, its design space only involves 72 transformers that are not flexible. Thus, there is a need for an exhaustive design space of transformer accelerators to implement co-design and obtain the best-performing transformer-accelerator pair. This pair should not only deliver high accuracy on a given task but also be energy-efficient and have a high throughput and low chip area.

Here, Bayesian optimization using second-order gradients and a heteroscedastic surrogate model for co-design, i.e., BOSHCODE, is leveraged. It is a scalable co-design framework that efficiently searches the hardware and software design spaces at scale. CODEBench proposes and uses BOSHCODE to search over significantly large design spaces (4.2×10⁸¹² CNNs and 2.3×10⁸ accelerators). EdgeTran leverages BOSHCODE to search over the joint space of FlexiBERT 2.0 and a set of off-the-shelf edge-AI devices, including Raspberry Pi, Apple M1 system-on-chip (SoC) with a central processing unit, CPU, and a GPU, Intel Neural Compute stick (a neural processing unit), and Nvidia Jetson Nano (SoC with both CPU and GPU).

BOSHCODE supports co-design with any two search spaces. It leverages second-order gradient-based optimization on an actively-trained surrogate model for performance prediction (which is the optimization objective). The surrogate model combines a natural parameter network (NPN), a teacher, and a student network. The NPN predicts the mean performance of the transformer-accelerator pair along with the aleatoric uncertainty. The teacher and student networks predict the epistemic uncertainty in performance. Epistemic uncertainty is the uncertainty in performance due to an unexplored design space. In contrast, aleatoric uncertainty refers to the uncertainty due to parameter initializations and variations in model performance due to different training recipes. BOSHCODE exploits epistemic and aleatoric uncertainty estimates to obtain the best design decisions for the transformer, the accelerator, and the model training recipe that maximizes accuracy.

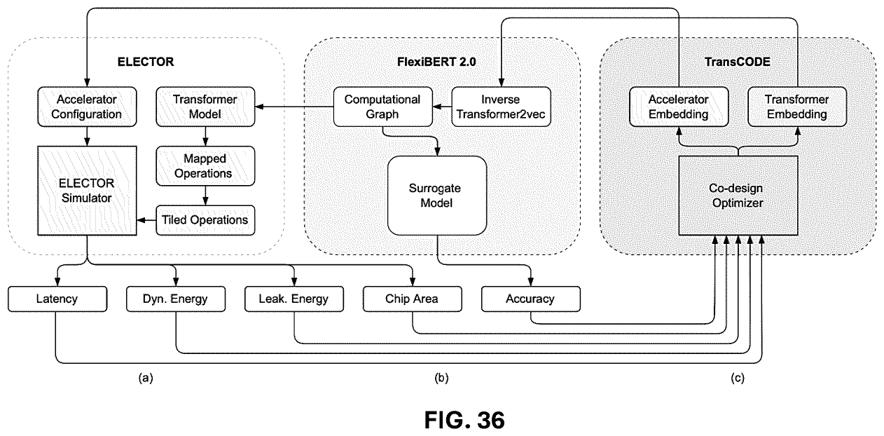

FIG. 36 shows an overview of the TransCODE framework. ELECTOR, in FIG. 36 (a), takes the accelerator embedding and transformer computational graph as input. Using the accelerator embedding, it implements a hardware accelerator with the corresponding design decisions. Next, it converts the computational graph into a corresponding transformer model with modular operations (supported by the FlexiBERT 2.0 design space), which it then maps to specialized hardware modules. It also tiles the matrices for efficient resource allocation, operation scheduling, and data reuse. FIG. 36 (b) shows how one can leverage the FlexiBERT 2.0 framework to convert a transformer embedding to its corresponding computational graph and employ the surrogate model to predict model accuracy. Finally, FIG. 36 (c) illustrates TransCODE, which uses previous performance results to train a surrogate model and query the next transformer-accelerator pair. Finally, it feeds the output accelerator and transformer embeddings to ELECTOR and FlexiBERT 2.0, respectively.

The dynamic inference and training technique, DynaProp, that prunes activations and gradients to skip ineffectual operations, can now be discussed. The ELECTOR simulator and the accelerator design choices it supports can then be described. Finally, the TransCODE pipeline that implements co-design and obtains the best-performing transformer-accelerator pair may be described.

### Dynamic Inference and Training

DynaTran is a low-overhead dynamic inference method that quickly prunes ineffectual weight and activation values at runtime. However, it only targets transformer inference and not training. It is proposed DynaProp can be used to induce sparsity in weights and activations at runtime (during inference) and gradients (during training). DynaProp takes an input matrix, which is either a weight matrix (loaded from memory), an activation matrix (obtained from previous MAC operations), or a gradient matrix (formed while backpropagating gradients). It then prunes values with a magnitude less than a given threshold T (i.e., it forces them to zero). Mathematically, one can prune an input matrix M∈ [symbol] ^{m×n} to MP as follows, and as described previously:

$${M}_{ij}^{P} = \{ \begin{matrix}{M}_{ij} & if \vert {M}_{ij} \vert \geq τ \\ 0 & if \vert {M}_{ij} \vert < τ\end{matrix}$$

One can implement each such comparison in parallel, thus requiring only one clock cycle for the pruning process. One can define the pruning ratio (or level of sparsity) of the output matrix as:

$$ρ ( {M}^{P} ) = \frac{{\sum }_{x ∈ {M}^{P}} {δ}_{z , 0}}{m \times n}$$

where δ is the Kronecker delta function. One can profile the resultant sparsity in weights, activations, and gradients for different transformer models on diverse applications to obtain a desired ρ. ELECTOR stores these curves in memory. For the desired values of ρ, one can determine the corresponding τ at runtime through a simple look-up operation.

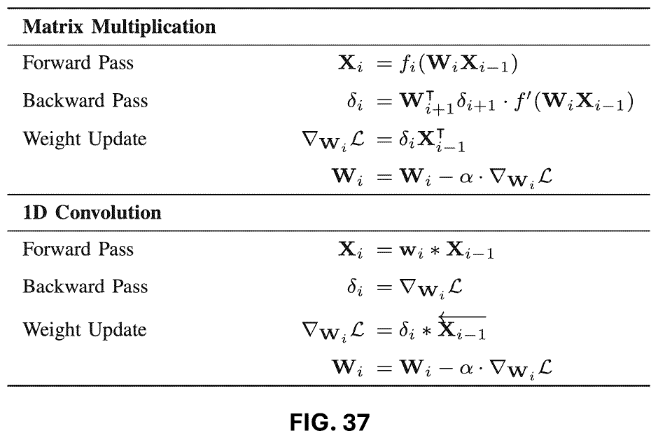

Table XII (FIG. 37) shows the operations underlying the forward and backward pass for matrix multiplication and one-dimensional (1D) convolution, respectively. The table shows that training requires the same operation types (as inference) and thus mandates identical hardware, although with a separate dataflow. One can also observe that the number of backward pass and weight update operations (executed during training) is more than the number of those for the forward pass (executed during inference). This shows that training is much more computationally expensive than inference, involving more activations and gradients that the accelerator needs to account for. DynaProp prunes each such matrix before it executes the respective operation in hardware. Thus, the accelerator skips ineffectual operations, improving latency and energy efficiency.

Optimizers like Adam would require extra computation (e.g., the calculation of momentum and storage of previous weights/gradients). These computations can easily be incorporated into the accelerators supported in the proposed design space. However, second-order gradients would add much more computational overhead.

### The ELECTOR Framework

Accelerators in the ELECTOR design space take inspiration from previously proposed state-of-the-art accelerators, including SPRING and AccelTran. One can divide the overall accelerator architecture into the accelerator tier and the (on-chip or off-chip) memory tier. FIG. 8 shows the organization of the accelerator tier in the proposed architecture, where it is noted that the “Activation Buffer” is an activation and gradient buffer. The control block receives the instruction stream of the transformer model from the host CPU. The direct memory access (DMA) controller fetches the weights and embeddings from the main memory. Thus, the PEs communicate with the on-chip buffers while the DMA controller transfers data between the buffers and the on-chip/off-chip main memory. The activation-and-gradient buffer stores the activations and gradients formed during transformer evaluation. The weight buffer stores the transformer weights. ELECTOR stores all data in a compressed format. Data compression relies on binary masks (stored in the mask buffer). The PEs employ the compressed data and associated masks to perform the main compute operations of any transformer in the FlexiBERT 2.0 design space.

### 1) Hardware Modules:

Main Memory: ELECTOR supports three memory types: an off-chip dynamic random access memory (DRAM) for scalable and economical deployments, an on-chip high-bandwidth memory (HBM) for memory-intensive edge/server applications, and an on-chip monolithic-3D resistive random access memory (RRAM). Monolithic-3D integration leverages monolithic inter-tier vias, allowing much higher density than traditional through-silicon-via-based 3D integration. This leaves much more logic space and permits high memory bandwidth, which are crucial for large transformer models in the FlexiBERT 2.0 design space.

Control Block: The control block takes the transformer model as input. It then converts all functions in the model into hardware-mappable operations that it later converts to tiled operations. For instance, it converts the matrix multiplication operation O=W×A to multiple operations of the form O[b,i,j]=W[b,i,k]×A[b,k,j], where each tiled matrix ∈ [symbol] ^{b×x×y} i.e., the tile size. The control block also assigns and schedules the tiled operations to different PEs.

Processing Elements: FIG. 9 shows the organization of a PE (the basic compute module of an accelerator) in the ELECTOR design space. Similar to what is noted above, it is noted that the ‘Activation FIFO’ is an activation/gradients FIFO. Further, the “DynaTran” module is replaced by a “DynaProp” module (see below). The local registers of the PE store the compressed data. These are the first-in-first-out (FIFO) registers for the activations (and gradients) and weights. The data then enter the DynaProp module that induces sparsity based on the desired p. This module prunes the given activation/gradient/weight matrices based on a pre-calculated threshold T. The PE then feeds the sparse data to the pre-compute sparsity module with the binary masks. These binary masks have the same shape as the uncompressed data, where each binary bit in a mask depicts if the corresponding element in the original data vector is ineffectual or not. The pre-compute sparsity module converts the input data into a zero-free format based on the associated masks. The PE then forwards this zero-free data to the MAC lanes (for matrix multiplication), softmax modules (for softmax operation), or the layer-norm module (for layer-norm operation). The zero-free data eliminate any ineffectual computations in these modules. Finally, the post-compute sparsity module implements the inverse of this operation on the output activations before storing them in the corresponding FIFO register and, eventually, the main buffer.

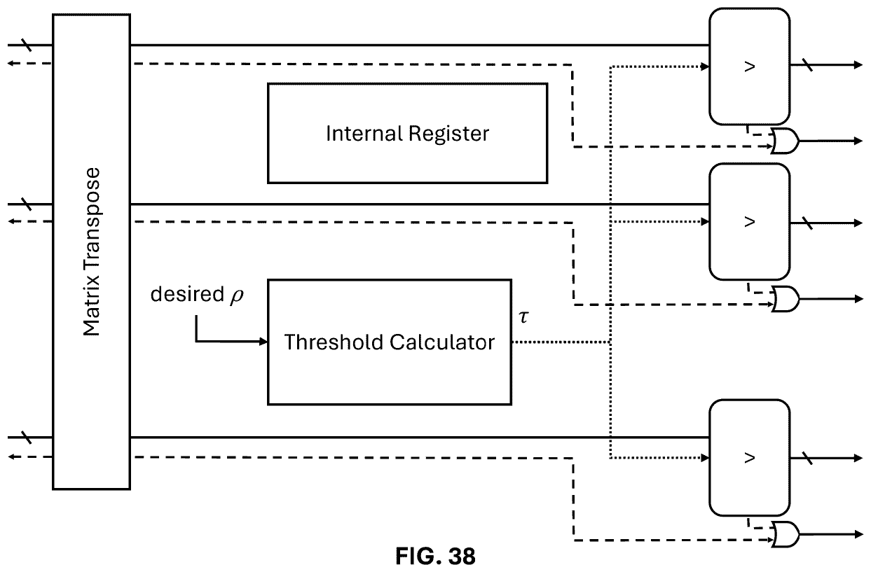

The MAC lanes execute multiplication between two tiles in a parallelized manner. We store all activation, gradient, and weight data in fixed-point format with (IL+FL) bits, denoting integer length (IL) and fractional length (FL), respectively. Data first reach M multipliers and then an adder tree with depth log₂M. The MAC lanes also include a ReLU and a GeLU module for feed-forward operations.
FIG. 38 shows the DynaProp module that executes dynamic inference and training on the transformer. It takes the input activation/gradient/weight matrix and prunes ineffectual values for efficient evaluation. The values of the input matrix are pruned by comparing their magnitude with a pre-determined threshold T. The DynaProp module implements this in parallel for the entire tile. An input tile M∈ [symbol] ^{b×x×y} is first fed to the matrix transpose block, which carries out the transpose operation, if required. Mathematically, it outputs M^{T}∈ [symbol] ^{b×x×y}, transposing all matrices in the batch of size b. It then feeds the input tile to b×x×y comparators. The threshold calculator determines the required threshold using the desired p and the pre-profiled transfer functions for different transformer models on diverse applications (stored in the internal register). If the output of the comparator is zero, the corresponding mask bit can be set to 1. Here, the lines carrying mask information are represented with dashed lines and those carrying activation/gradient/weight information in solid black.
For all other hardware modules, the proposed implementation of AccelTran is used. However, the operation executability of all modules (e.g., support for different tile sizes in the softmax module) is expanded.

The optimal selection of the number of PEs, buffer sizes, and other design choices results in the highest possible resource utilization while minimizing the number of compute/memory stalls (when we do not execute either a compute operation or a memory fetch operation). Hence, determining the best accelerator hyperparameters is essential for energy-efficient designs with a low chip area and high throughput.

### 2) The Transformer Mapper:

The FlexiBERT 2.0 design space supports various operation types. Each operation is described next.
Self-attention: The self-attention (SA) operation finds how much one token attends to another token. For an output attention head Hg∈ [symbol] ^{N}^{_{T}}^{×d}^{ₒᵤₜ} with query Qᵢ∈ [symbol] ^{N}^{_{T}}^{×h/n}, key Kᵢ∈R^{N}^{_{T}}^{×h/n} and value Vᵢ∈ [symbol] ^{N}^{_{T}}^{×h/n} matrices:

$${H}_{i} = soft max ( SA ) {V}_{i} {W}_{i}^{o}$$

where N_{T} is the input sequence length, h is the hidden dimension of the encoder layer, and n is the number of heads. The SA operation has two sub-types:
The scaled dot-product (SDP) attention is the de-facto standard operation in traditional transformer architectures. Mathematically,

$${SA}_{SDP} := \frac{{Q}_{i} {K}_{i}^{T}}{\sqrt{h}}$$

The weighted multiplicative attention (WMA) involves a trainable weight matrix Wₒ∈ [symbol] ^{h/n×h/n} such that

$${SA}_{WMA} := \frac{{Q}_{i} {W}_{o} {K}_{i}^{T}}{\sqrt{h}}$$

The mapper converts the self-attention operation into various MAC and softmax operations that the corresponding hardware modules can execute in the accelerator.
Linear Transform: As the name suggests, this operation implements a linear transform (LT) on the input sequence. The FlexiBERT 2.0 design space supports two sub-types:
The discrete Fourier transform (DFT) that may be implement in hardware using the corresponding Vandermonde matrix VDFT∈ [symbol] ^{N}^{_{T}}^{×N}^{_{T}} for the roots of unity (also called the DFT matrix) such that

$${LT}_{DFT} := {V}_{DFT} H$$

where H∈ [symbol] ^{N}^{_{T}}^{×d}^{ᵢₙ} represents a matrix for the input hidden states.

The discrete cosine transform (DCT) that may again be implemented using an equivalent [symbol] Vandermonde matrix V_{DCT}∈^{N}^{_{T}}^{×N}^{_{T}} such that

$${LT}_{DCT} := {V}_{DCT} H$$

The VDFT and VDCT matrices are stored in the buffer for subsequent use while executing the above operations. Although these operations are slower than the fast Fourier transform (FFT) and the fast cosine transform (FCT), respectively, sparsification of the input matrices results in a low overall execution time. Furthermore, converting these operations to MAC operations enables the reuse of the MAC lanes, thus not requiring special hardware modules for the LT operation. Nevertheless, these methods (FFT and FCT) may lead to high gains for transformer models that support long sequences, due to their [symbol] (N log N) complexity.
Dynamic-span-based Convolution: The dynamic-span-based convolution (DSC) operation implements a 1D convolution over the input. Mathematically,

$${DSC}_{k} := {w}_{k} * H$$

where wₖ is the convolution kernel of length k. To implement this operation in hardware, one can convert the convolution operation into an equivalent matrix multiplication operation. In other words, one can convert the convolutional kernel to a sparse matrix that is multiplied with the input. One can tweak the MAC lane module to incorporate this conversion.

Now that the mapper has converted the operations in the FlexiBERT 2.0 design space to hardware-implementable formats, the control block tiles, schedules, and assigns these mapped operations to the accelerator for transformer evaluation.

### 3) Design Space:

ELECTOR supports various accelerators in its design space. It allows adaptation of many design decisions in an ASIC-based accelerator. These tunable hyperparameters are described next.
Batch Tile Size: This is the size of a tile along the batch. Mathematically, a tile M∈ [symbol] ^{b×x×y} has the batch tile size b.
Spatial Tile Size: This is the size of a tile orthogonal to the batch dimension. In the above example, x=y is the spatial tile size (assuming square matrices for the tiles). A higher tile size (either b or x/y) would imply that each hardware module (MAC lane, softmax module, or layer-norm module) could execute more operations in parallel since the module evaluates a larger tile. This enables latency reduction at the cost of higher dynamic power.
Activation Function: Transformer evaluation uses a non-linear function following a feed-forward operation. In some examples, two functions are supported: ReLU and GeLU. This is in accordance with the FlexiBERT 2.0 design space.
Number of PEs: The number of PEs in the accelerator.
Number of MAC Lanes per PE: The number of MAC lanes in each PE of the accelerator. The number of MAC lanes may preferably kept constant for every PE.

Number of MACs per Lane: The number of MAC units per MAC lane. Again, this may preferably be constant across all MAC units.
Number of Softmax Modules per PE: The number of softmax modules in each PE. Every PE has only one layer-norm module. Therefore, the number of MAC lanes and softmax modules in each PE determines the net ratio of the number of MAC lanes, softmax modules, and layer-norm modules in an accelerator. One can tune this ratio based on the corresponding proportion of these operations in evaluating the selected transformer.
BatchSize: The batch size for transformer evaluation. More compute resources and high bandwidth memory enable a larger batch, reducing evaluation latency.
Activation and Gradient Buffer Size: The size of the activation/gradient buffer. Training requires more activation matrices than inference. It also has gradient matrices, requiring a larger buffer size.
Weight Buffer Size: The size of the weight buffer. A larger transformer model requires a larger weight buffer.
Mask Buffer Size: The size of the mask buffer that stores the binary masks for the zero-free format used in the accelerators in ELECTOR.

Table XIII, below, summarizes the possible design choices for accelerators in the ELECTOR design space. The possible memory configurations include the memory type (RRAM, DRAM, and HBM) along with the banks, ranks, and channels.

TABLE XIII
Hyperparameters supported in the ELECTOR design space.

| Hyperparameter | Permissible Values |
|---|---|
| Batch tile size | 1, 4 |
| Spatial tile size | 8, 16, 32 |
| Activation Function | ReLU, GeLU |
| #Pes | 64, 128, 256, 512, 1024 |
| #MAC lanes per PE | 8, 16, 32, 64, 128 |
| #MACs per lane | 1, 16 |
| #Softmax modules per PE | 2, 4, 8, 16, 32, 64 |
| Batch Size | 4, 16, 32 |
| Act./Grad. buffer size (MB) | 4, 8, 16, 32, 64 |
| Weight buffer size (MB) | 8, 16, 32, 64, 128 |
| Mask buffer size (MB) | 1, 2, 4, 8, 16 |
| Main memory configuration | RRAM: [16, 2, 2], [8, 2, 4], [4, 2, 8], |
| [banks, ranks, channels] | [2, 2, 16], [32, 2, 1], [1, 2, 32] |
| | DRAM: [16, 2, 2], [8, 2, 4], |
| | [32, 2, 1], [16, 4, 1] |
| | HBM: [32, 1, 4] |

### 4) Accelerator Embeddings:

How the selected accelerator configuration (a sample from Table XIII) is converted to an embedding for surrogate modeling may now be described. One can generate a 12-dimensional embedding (e) for a selected accelerator configuration as follows:
e₁ denotes the batch tile size, i.e., e₁=b.
e₂ and e₃ correspond to the spatial tile sizes, i.e., e₂=x, e₃=y. For the targeted design space, e₂=e₃.
e₄ denotes the number of PEs.
e₅ denotes the number of MAC lanes per PE.
e₆ denotes the number of MACs per lane.
e₇ denotes the number of softmax modules in each PE.
e₈ denotes the selected batch size for model evaluation.
e₉, e₁₀, and e₁₁ denote the activation/gradient, weight, and mask buffer sizes, respectively, in MBs.
e₁₂ denotes the index of possible memory configurations in Table XIII, thus ranges from 1 to 11. These generated embeddings are used to train the TransCODE surrogate model, which also outputs the subsequent query as an accelerator embedding.

### 5) Simulation Flow:

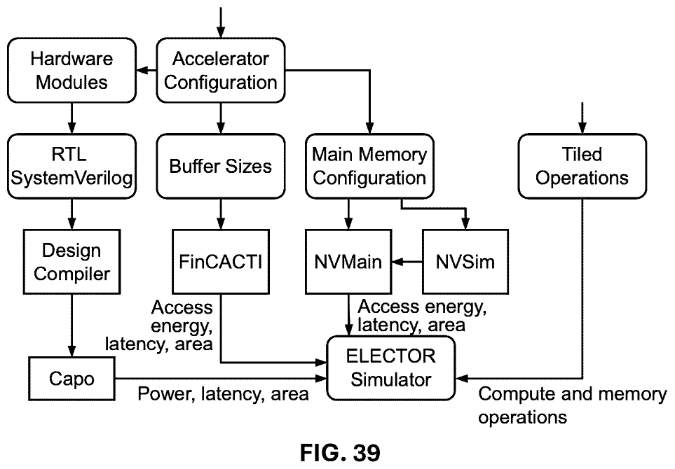

FIG. 39 shows the simulation flow for evaluating an input accelerator configuration and tiled operations (obtained after mapping and tiling the input trans-former) in ELECTOR. One first selects the compute modules (including the tile size for parallel operation), buffer sizes, and main memory configuration. Next, one implements different hardware modules (e.g., modules as disclosed herein) at the register-transfer level (RTL) using SystemVerilog. One can use, e.g., Design Compiler to synthesize the RTL design based on a 14 nm FinFET technology library. Capo, an open-source floorplacer, performs floorplanning. FinCACTI, a cache modeling tool for deeply-scaled FinFETs, models the on-chip buffers. NVSim and NVMain model the main memory (either the off-chip DRAM or on-chip HBM/RRAM). ELECTOR then plugs the synthesized results into a Python-based cycle-accurate simulator. Finally, the control block segregates the tiled operations into compute and memory operations for separate execution pipelines.

### C. TransCODE

BOSHCODE is used to obtain the best-performing transformer-accelerator pair. BOSHCODE takes as input the accelerator and transformer embeddings and outputs the performance measure to be estimated. For the transformer embeddings, one can use the embeddings used in FlexiBERT 2.0 as opposed to the Transformer2vec encodings since they are fast and efficient. This is critical for exploring the vast FlexiBERT 2.0 design space efficiently. For the accelerator embeddings, one can use the embeddings from the accelerator configuration disclosed herein. Similar to Eq. (1), one can define the output performance measure as follows:

Performance=α×(1−Latency)+β×(1−Area)+γ×(1−Dynamic Energy)+δ×(1−Leakage Energy)+∈×Accuracy, where α+β+γ+δ+ε=1 are hyperparameters. One can normalize the values of the individual performance measures with respect to their maximum values (hence, these values reside in the [0,1] interval). Thus, for edge applications where the power envelope of devices is highly restricted (for example, for devices operating on a battery, such as phones, tablets, etc., or otherwise not connected to the power grid, such as satellites.), users can set the hyperparameters γ and δ high. On the other hand, for server-side deployments, where accuracy is of utmost importance, one can set F high.

TransCODE generally needs five performance values for the queried transformer-accelerator pair: latency, area, dynamic energy, leakage energy, and model accuracy. To obtain the first four performance values, one can leverage the ELECTOR simulator. To obtain the transformer model accuracy, one can employ the FlexiBERT 2.0 surrogate model, which outputs the GLUE score.

To test the efficacy of the DynaProp method, transformer models were evaluated in the FlexiBERT 2.0 design space. Table XIV shows the hyperparameter ranges supported by the FlexiBERT 2.0 design space.

TABLE XIV
Hyperparameter ranges in FlexiBERT 2.0 design space,
superscript (j) depicts the value for layer j.

| Design Element | Allowed Values |
|---|---|
| Number of encoder layers (l) | {2, 4, 6, 8, 10, 12} |
| Type of attention | {SA, LT, DSC} |
| operation used (o^{j}) | |
| Number of operation heads (n^{j}) | {2, 4, 8, 12} |
| Hidden size (h^{j}) | {128, 256} |
| Feed-forward dimension (f^{j}) | {256, 512, 1024, |
| | 2048, 3072, 4096} |
| Number of feed-forward stacks | {1, 2, 3} |
| Operation parameters (p^{j}) | |
| if o^{j} = SA | Self-attention type: {SDP, WMA} |
| else if o^{j} = LT | Linear transform type: {DFT, DCT} |
| else if o^{j} = DSC | Convolution kernel size: {5, 9} |

Evidently, shallow models (e.g., with two encoder layers) incur lower latency relative to deep models (e.g., with 12 encoder layers). Moreover, wide models (e.g., with 12 attention heads) require more compute resources to enable higher parallelization than narrow ones (e.g., with two attention heads). Further, different attention-head types have different latencies and energy consumption characteristics. Hence, there is a need for optimized dataflows when executing such heterogeneous architectures.

The models are tested on representative natural language understanding tasks under the GLUE benchmark. The included tasks are: SST-2, MNLI, QQP, QNLI, MRPC, CoLA, STS-B, RTE, and WNLI. The surrogate model trained on the FlexiBERT 2.0 design space reports the overall GLUE score. The training sizes and used metrics are shown in in Table XV. The GLUE score represents average performance across all the tasks.

TABLE XV
Data statistics of datasets in the GLUE bench- mark.

| Task | Training Size | Metric |
|---|---|---|
| SST-2 | 67K | Accuracy |
| MNLI | 393K | Accuracy |
| QQP | 364K | Accuracy |
| QNLI | 105K | Accuracy |
| MRPC | 3.7K | Accuracy |
| CoLA | 8.5K | Matthew's Correlation |
| STS-B | 7K | Spearman Correlation |
| RTE | 2.5K | Accuracy |
| WNLI | 634 | Accuracy |

While running DynaProp, in these examples activation, weight, and gradient sparsity are targeted, Weight sparsity is static and depends on pruning performed during model pre-training or finetuning. Activation and gradient sparsity change for every input sequence—their averages may be reported over the entire validation set.

### B. The ELECTOR Design Space

Table XIII summarizes the ELECTOR design space. Taking into account all the possible combinations presented in this table, ELECTOR supports 14,850,000 accelerators in its design space. This space includes accelerators meant for resource-constrained edge applications as well as those relevant to high-energy server settings that require high throughput. In addition, ELECTOR allows different memory configurations to support diverse user requirements, from high-bandwidth monolithic-3D RRAM to economic off-chip DRAM.

### C. Co-design Pipeline

To run BOSHCODE, the following parameter values were used to obtain the net performance measure: α=0.1, β=0.1, γ=0.2, δ=0.1, and ε=0.5. The network and hyperparameters used in EdgeTran were leveraged for co-design. The BOSHCODE model takes x_{TXF} and x_{ACC} as input and outputs the predicted performance measure. Here, x_{TXF} and x_{ACC} correspond to the FlexiBERT 2.0 and ELECTOR embeddings, respectively. BOSHCODE then leverages gradient-based optimization using backpropagation to the input (GOBI) while freezing the model weights.

All input embeddings obtained using GOBI from the surrogate models may not be valid. For instance, x_{ACC} should be well-defined (e.g., one can allow the batch tile size, b, to only be 1 or 4). To add constraints to the optimization process, along with forcing the model to learn the performance only for valid input embeddings, one can add a datapoint (x_{TXF}, x_{ACC}, P_{MIN}) to the dataset if either of the input embeddings is invalid or does not adhere to user-defined constraints. Another example of an input constraint could be that transformers with only up to six layers are allowed. P_{MIN} has a low value, set to −1 for some experiments (where well-defined inputs would result in P to lie in the [0,1] range).

### Dynamic Pruning of Transformer Weights, Activations, and Gradients

The memory required for three evaluation modes: inference, traditional training, and DynaProp training, were compared for BERT-Tiny and BERT-Base. The evaluation mode does not affect the memory usage for the token and position embeddings. Moreover, inference and training require the same memory size for transformer model weights. However, training generates gradients and also more activation operations. Here, the δ's described in FIG. 37 define the gradient memory consumption. For BERT-Tiny and BERT-Base, training requires 2.8× and 2.1× more memory (for activations and gradients), respectively. However, the buffer can be smaller since it only stores the activations or gradients required by the PEs at a given time. DynaProp was configured to induce 50% sparsity in weights and activations (resulting in no loss in accuracy) and 90% sparsity in the gradients (with only marginal accuracy loss). DynaProp thus requires 1.5× and 1.9× smaller memory for BERT-Tiny and BERT-Base, respectively, while running training. This results in a smaller main memory, smaller buffers, and fewer MAC operations, thus leading to improved throughput.

To decouple and study the effects of pruning while running model inference and training, DynaProp was executed with two pruning thresholds: τ₁ and τ_{T}. It prunes activation and gradient matrices using τ₁ for the forward pass and τ_{T} for the backward pass. It leverages movement pruning for transformer weights. A contour plot showing the effect of these thresholds on accuracy for the BERT-Tiny model was created, and—as previously observed—the accuracy first increases and then decreases as one increases τ₁. However, accuracy monotonically decreases on increasing τ_{T}. When considering the average between activation and gradient sparsities (or the net sparsity) when changing τ₁ and τ_{T}, The net sparsity increases as both τ₁ and τ_{T} increase.

Unlike pruning during inference (using τ₁), accuracy decreases under DynaProp as one increases the pruning threshold τ_{T}. However, this loss in accuracy is a result of high gradient sparsity. This enables ELECTOR to skip many ineffectual MAC operations, reducing energy consumption and latency. 90% gradient sparsity was achieved when τ_{T} was set to 0.0001 with an accuracy loss of only 0.4%. Net sparsity may be considered as the average of the activation and gradient sparsities (weight sparsity remains constant at 50%). Here, accuracy decreases with increasing net sparsity for BERT-Base. However, for BERT-Tiny, accuracy increases and decreases as one increases net sparsity.

The BERT-Tiny model was evaluated on an Nvidia A100 GPU and an ELECTOR-supported accelerator (AccelTran-Edge with added training support). Training takes 761.9× longer than inference on a GPU. However, ELECTOR only requires 1.6× more time. This is due to optimized scheduling, tiling of operation matrices, specialized hardware modules, and a dataflow curated for transformer workflows. Since an off-the-shelf GPU does not automatically skip ineffectual computations (in other words, it is not sparsity-aware), DynaProp training hardly reduces evaluation time on the A100 GPU. However, due to the zero-free data format and specially designed hardware modules that skip ineffectual operations, ELECTOR reduces the training time by 2.3×. Thus, high activation, weight, and gradient sparsities enabled by DynaProp, along with ASIC-based acceleration, allow ELECTOR to substantially reduce evaluation times relative to a baseline GPU.

### Design Space Exploration

Convergence plots were created while executing co-design using BOSHCODE and various baselines. These baselines include random search, gradient-boosted regression trees (GBRT), Gaussian-process-based Bayesian optimization (GP-BO) that approximates performance through Gaussian process regression and optimizes it through the L-BFGS method, and random forest that fits various randomized decision trees over sub-samples of the dataset. BOSHCODE achieves the highest performance. It yields the optimal transformer-accelerator pair, FB*-ELECTOR* (FB is an acronym for FlexiBERT 2.0). Here, performance refers to the net measure found using a convex combination of accuracy, latency, area, dynamic energy, and leakage energy.

In one example, to optimize latency, FB* uses only two encoder layers. However, FB* uses 12 attention heads in each encoder layer to avoid performance loss. Thus, BOSHCODE searches for a shallow but wide model to improve throughput while not incurring a performance penalty. The converged architecture is also highly heterogeneous, with diverse attention types in each layer, leveraging the modeling capabilities of each operation type. ELECTOR* has many PEs to parallelize the computation of 12 attention heads in each FB* layer. It also leverages monolithic-3D RRAM, which has the highest bandwidth and lowest energy consumption. The net area of this accelerator is 359.3 mm².

One can compare the converged transformer-accelerator pairs obtained by the proposed approach with baseline pairs. Pareto frontiers of GLUE scores with respect to hardware measures, i.e., latency, chip area, and energy consumption, can be produced. GLUE scores may be obtained from the surrogate model described in the EdgeTran framework. One can also plot state-of-the-art transformer-accelerator pairs for comparison. The pair on the Pareto frontier with the same accuracy as BERT-Base evaluated on AccelTran-Server incurs 44.8× lower latency. On the other hand, the pair on the Pareto frontier with the same latency as that of BERT-Tiny evaluated on AccelTran-Edge achieves a 14.5% higher GLUE score. Similarly, the pair with the same accuracy as that of BERT-Base evaluated on AccelTran-Server but on Pareto frontier related to chip area requires 34.5× lower chip area. The one with the same chip area as that evaluated on AccelTran-Edge finds a transformer model on the frontier that achieves a 14.8% higher GLUE score. Finally, the pair with the same accuracy as that of BERT-Base incurs 1050× lower energy consumption than that of the model evaluated on AccelTran-Server. In contrast, the same-energy pair with BERT-Tiny evaluated on AccelTran-Edge, but on the Pareto frontier, achieves a 13.9% higher GLUE score.

An ablation study was implemented in which HW-NAS (by forcing the gradients to the accelerator to zero) with AccelTran-Server as the base accelerator. FB*-ELECTOR* outperforms the state-of-the-art pair, i.e., BERT-Base/AccelTran-Server, achieving 0.3% higher accuracy, 5.2× lower latency, and 3.0× lower energy consumption.

Various modifications may be made to the systems, methods, apparatus, mechanisms, techniques, and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiment

What is claimed is:

1. A method for co-designing transformer-accelerator pairs comprising:
using a transformer embedding to generate a computational graph and a transformer model;
running the computational graph through a surrogate model and outputting accuracy data of said surrogate model;
using an accelerator embedding and said transformer model to simulate training and inference tasks and outputting hardware performance data of said transformer model;
sending the hardware performance data and model accuracy data to a co-design optimizer; and
generating an output transformer-accelerator or a transformer-edge-device pair from said co-design optimizer.

2. The method of claim 1, wherein the transformer model and accelerator embedding are the output transformer-accelerator or a transformer-edge-device pair.

3. The method of claim 1, wherein the hardware performance data includes: latency, energy leakage, dynamic energy, and chip area.

4. The method of claim 3, wherein the latency, energy leakage, dynamic energy, chip area, and model accuracy are optimizable performance parameters.

5. The method of claim 4, wherein the dynamic energy and energy leakage parameters are optimized where a device's power envelope is highly restricted.

6. The method of claim 4, wherein the model accuracy is optimized for server-side deployments.

7. A system for co-designing transformer-accelerator pairs, the system comprising one or more processing units configured to, collectively:
generate a computational graph and transformer model from a transformer embedding;
run the computational graph through a surrogate model and output accuracy data of said surrogate model;
use an accelerator/edge-device embedding and said transformer model to simulate training and/or inference tasks and outputting hardware performance data of said transformer model;
send the outputted hardware performance data and model accuracy data to a co-design optimizer; and
output from the co-design optimizer a transformer-accelerator or a transformer-edge-device pair.

8. The system of claim 7, wherein the hardware performance data includes: latency, energy leakage, dynamic energy, and chip area.

9. A non-transitory computer-readable medium having stored thereon a computer program for execution by a processor configured to perform a method for co-designing transformer-accelerator pairs, the method comprising:
using a transformer embedding to generate a computational graph and a transformer model;
running the computational graph through a surrogate model and outputting accuracy data of said surrogate model;
using an accelerator/edge-device embedding and said transformer model to simulate training and inference tasks and outputting hardware performance data of said transformer model;
sending the hardware performance data and model accuracy data to a co-design optimizer; and
generating an output transformer-accelerator or a transformer-edge-device pair from said co-design optimizer.

10. The non-transitory computer-readable medium of claim 9, wherein the hardware performance data includes latency, energy leakage, dynamic energy, and chip area.

11. A method for profiling processing unit performance, comprising:
converting a surrogate model to a computational graph and training a machine learning model on said computational graph;
running inferences for a natural language processing task on at least one processing unit; and
outputting hardware performance data of the at least one processing unit generated from the natural language processing task.

12. The method of claim 11, wherein the hardware performance data includes: latency, energy leakage, dynamic energy, and chip area.

13. The method of claim 11, wherein the at least one processing unit is one of a graphics processing unit and a central processing unit.

14. A method for profiling accuracy of a transformer model, comprising:
converting a set of transformer model architecture parameters to a computational graph;
generating from said computational graph a transformer model;
passing the transformer model through a model training module; and
outputting accuracy data of the trained transformer model.

15. The method of claim 14, wherein the model training module is tuned during transformer model training.
